(19) United States
(12) Patent Application Publication
(10) Pub. No.: US 2024/0237644 A1
(43) Pub. Date: Jul. 18, 2024

(54) OIL FLOWABLE APYRASE INHIBITOR FORMULATION

(71) Applicant: Texas Crop Science, Inc., Austin, TX (US)

(72) Inventors: Jeffrey D. Fowler, Austin, TX (US); Simon Hiebert, Austin, TX (US)

(21) Appl. No.: 18/391,459

(22) Filed: Dec. 20, 2023

Related U.S. Application Data
(60) Provisional application No. 63/476,309, filed on Dec. 20, 2022.

(51) Int. Cl. A01N 37/50; A01N 25/04; A01P 3/00

(52) U.S. Cl. CPC A01N 37/50; A01N 25/04; A01P 3/00

(57) ABSTRACT

The disclosure concerns an oil flowable formulation comprising a first active compound having a structure

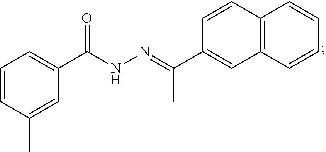 [SMILES: C/C(=N\NC(=O)c1cccc(C)c1)c1ccc2ccccc2c1]

and a lipophilic solvent, a first dispersant, and a rheology modifier. The formulation comprises particles of the first active compound having a median particle size, as measured by light scattering, of from 0.1 to 20 microns. The formulation may also comprise an emulsifier, a second dispersant, and/or an agriculturally active compound, such as an acaricide, antimicrobial, fungicide, herbicide, insecticide, molluscicide, or nematocide, or a combination thereof. Also disclosed are agricultural compositions comprising the formulation and methods of using the same.

### CROSS REFERENCE TO RELATED APPLICATION

This application claims the benefit of the earlier filing date of U.S. provisional patent application No. 63/476,309, filed Dec. 20, 2022, which is incorporated herein by reference in its entirety.

### FIELD

The present disclosure relates to an oil flowable apyrase inhibitor formulation and methods for its use, in particular in the treatment of crops susceptible to pathogens.

### BACKGROUND

Crops are plagued worldwide by a variety of pathogens. Pathogens, such as insects, mites, nematodes, weeds and fungi have developed an array of mechanisms for surviving pesticides, such as by sequestering, exporting or detoxifying them. There is a need for formulations to potentiate the efficacy of pesticides by blocking certain mechanisms of resistance.

### SUMMARY

Disclosed herein is a composition comprising a compound having a structure

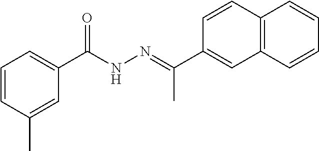 [SMILES: C/C(=N\NC(=O)c1cccc(C)c1)c1ccc2ccccc2c1]

a lipophilic solvent, a first dispersant, and a rheology modifier. In some embodiments, the compound is substantially insoluble in the lipophilic solvent.

In some embodiments, the compound is present in the form of particles, for example, particles having a volume-weighted median particle size ranging from greater than 0.01 microns to 40 microns, such as from 0.01 microns to 30 microns, from 0.01 microns to 25 microns, such as ranging from greater than 0.01 microns to 20 microns, such as from 0.1 microns to 5 microns, or from 0.5 microns to 2 microns, and in certain embodiments, the volume-weighted median particle size is 1 micron. In some embodiments, the particles are present in an amount from 5 wt % to 90 wt %, such as from 30 wt % to 85 wt %, or from 30 wt % to 50 wt %.

The lipophilic solvent may comprise mineral oil, a fatty acid, a vegetable or seed oil, a terpene, an aliphatic solvent, a cyclic hydrocarbon solvent, an aromatic solvent, or derivatives and/or combinations thereof. In some embodiments, the lipophilic solvent comprises a fatty acid derivative. The fatty acid derivative may be selected from fatty acid esters, fatty acid dialkyl amides and combinations thereof. In some embodiments, the fatty acid derivative may comprise an oleate, such as methyl oleate.

In other embodiments, the lipophilic solvent comprises a paraffinic solvent. And in further embodiments, the lipophilic solvent comprises an aromatic solvent, and may comprise tetrahydronaphthalene, an alkylated naphthalene, derivatives thereof, or combinations thereof.

The rheology modifier may comprise an organo-modified clay, a silica or hydrophobically-modified silica, an alumina, a polyurethane-based polymer, or a combination thereof. In some embodiments, the rheology modifier is present in an amount of from 0.1 wt % to 15 wt %, such as from 1 wt % to 10 wt %.

In any embodiments, the first dispersant has a molecular weight of from 1,000 Daltons to 100,000 Daltons and is fully soluble in the lipophilic solvent. The first dispersant may be present in an amount of from 0.1 wt % to 20 wt %, such as from 1 wt % to 10 wt %.

The first dispersant may be an anionic dispersant, a cationic dispersant, a non-ionic dispersant, or a combination thereof. In some embodiments, the first dispersant is an anionic dispersant. In other embodiments, the first dispersant is a nonionic dispersant. In some embodiments, the first dispersant is selected from a homo-polymeric dispersant, a random or statistical copolymer, a block copolymer, or a combination thereof. In certain embodiments, the first dispersant is a copolymer, and may be a random or statistical copolymer, a block copolymer, a comb-structured block copolymer, or a combination thereof.

In some embodiments, the composition further comprises an emulsifier and a second dispersant. The emulsifier may be an anionic surfactant, a cationic surfactant, a nonionic surfactant, a quaternary ammonium surfactant, a zwitterionic surfactant, or a combination thereof, and/or may have a molecular weight of from 150 Daltons to 1,200 Daltons.

In some embodiments, the second dispersant has a molecular weight of from 1,000 Daltons to 100,000 Daltons and/or is soluble in water.

In some embodiments, the composition does not comprise more than 0.1 wt % of a compound comprising a primary amine, secondary amine, and/or tertiary amine.

In some embodiments, the composition does not comprise more than 0.1 wt % of a quaternary ammonium compound.

In any embodiments, the composition may further comprise an agriculturally active compound.

Also disclosed therein are embodiments of an agricultural composition, comprising water and/or a lipophilic solvent and the composition disclosed herein, such as from 0.01 wt % to 10 wt % of the composition. A method for using the agricultural composition also is disclosed. The method may comprise applying the agricultural composition to a plant, a part of a plant, a seed, soil where a plant is or will be growing, or soil where a seed has been or will be sown.

Methods for controlling or preventing fungal growth using the disclosed composition, or an agricultural composition thereof, also are disclosed.

The foregoing and other objects, features, and advantages of the invention will become more apparent from the following detailed description.

### DETAILED DESCRIPTION

### I. Terms

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. All references, including patents and patent applications cited herein, are incorporated by reference in their entirety, unless otherwise specified.

Unless otherwise indicated, all numbers expressing quantities of components, molecular weights, percentages, temperatures, times, and so forth, as used in the specification or claims, are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is expressly recited.

Unless explained otherwise, all technical and scientific terms used herein have the same meaning as commonly understood by one of ordinary skill in the art to which this disclosure pertains. Although methods and materials similar or equivalent to those described herein can be used in the practice or testing of the present disclosure, suitable methods and materials are described below. The materials, methods, and examples are illustrative only and not intended to be limiting.

“Administering” refers to any suitable mode of administration, to control a pathogen, such as a fungal pathogen, including, treatment of an extant crop, agricultural produce, seeds, soil or combination thereof.

“In combination with” refers to the administration of compounds either simultaneously in a single administration, or sequentially in two or more different administrations, that may be separated either in time, location, or method.

“Control” with reference to a pathogen, such as a fungal pathogen, means block, inhibit and/or eradicate a pathogen and/or prevent the pathogen from damaging a crop. In one embodiment, control refers to the reduction of one or more pathogen, such as a fungi, to undetectable levels, or to the reduction or suppression of a pathogen to acceptable levels as determined by one of ordinary skill in the art (for example, a crop grower). Determinations of acceptable levels of pathogen reduction are based on a number of factors, including to the crop, pathogen, severity of the pathogen, use restrictions, economic thresholds and other factors known to those of ordinary skill in the art.

As used herein, the terms “enhancer” and “potentiator”, refer to a compound or compounds disclosed herein that enhance the effects of a pesticide. Without limitation to theory the present enhancer compounds disclosed herein may function by blocking one or more pathways by which a pathogen, such as a fungal pathogen, evades toxicity, such as by detoxifying, sequestering or transporting a pesticide. In certain embodiments, the present compounds inhibit enzymatic apyrase activity which leads to the enhancement, accentuation or potentiation of a pesticide, such as an acaricide, antimicrobial, fungicide, herbicide, insecticide, molluscicide and/or nematocide. For example, when the enhancer or potentiator is used in conjunction with a fungicide, the combination of the potentiator and the fungicide enhances the fungicidal effect of the fungicide and/or renders a fungus that has become resistant to the fungicide susceptible to the fungicide as a result of the activity of the potentiator. Most often, these enhancers or potentiators do not themselves inhibit the growth of a pathogen, such as a fungus, itself, nor do they have a detrimental effect on a living organism that is (or could be) infected with a pathogen.

As used herein, the term “treatment” refers to a method used to administer or apply an effective amount of a disclosed compound or formulation thereof to a target area of a field and/or plant. The treatment method can be, but is not limited to, aerosol spray, pressure spray, direct watering, chemigation, fogging, and dipping. Target areas of a plant could include, but are not limited to, the leaves, roots, stems, buds, flowers, fruit, seed of the plant, and bulbs of the plant including bulb, corm, rhizoma, stem tuber, root tuber and rhizophore. Treatment can include a method wherein a plant is treated in one area (for example, the root zone or foliage) and another area of the plant becomes protected (for example, foliage is protected when a disclosed compound is applied in the root zone or new growth when applied to foliage).

As used herein, the term “oil flowable,” “oil miscible flowable concentrate,” “oil miscible suspension” or “OF,” refers to a liquid formulation that contains a stable suspension of active ingredient in an oil. Oil flowable formulations can be stored and can be provided to the market and/or end user without further processing. In practical application, oil flowable formulations are prepared for application by the end user. Typically, an oil flowable formulation is mixed with water and/or a lipophilic solvent in the end user's spray tank to the proper dilution for the particular application. Dilution can vary by crop, pathogen, time of year, geography, local regulations, and intensity of infection among other factors. Once properly diluted, the formulation can be applied, such as by spraying.

### II. Formulation

A common goal for the formulator of agricultural products is to maximize the biological activity of the active ingredient. In suspension formulations this is particularly challenging because the solid state of the active ingredient tends to limit biological availability. It is, however, not generally predictable whether a particular active ingredient will have good biological activity or not when delivered as a suspension. Without being limited by a theoretical understanding, factors that can determine biological activity include the solubility in water (including how that varies with temperature, salinity and pH at the site of application), the solubility in hydrophobic domains (including within waxy leaf cuticles and any micellar surfactant domains), the crystal lattice energy, the density of the active ingredient crystals and therefore their tendency to sediment, the existence of crystal polymorphs and metastable states, the diffusivity in water, the ability of the active ingredient to diffuse through the plant cuticle, the location of the site where the active ingredient acts, and the required concentration of the active ingredient at that site. A large number of modifications are potentially discoverable by the formulator to overcome limitations in biological activity, and many of these modifications have influences that are dependent upon each other (meaning that testing each of them separately does not adequately inform about outcomes when each are varied simultaneously) and it is therefore not feasible to explore the entire experimental space.

Amongst formulations tested during work described in the present disclosure, the inventors have discovered that oil flowable formulations of (E)-3-methyl-N′-(1-(naphthalen-2-yl) ethylidene)benzohydrazide generally have poor biological activity. It has been further discovered that, with formulations containing the required components described herein, the biological activity is greatly improved by controlling the particle size within a particular size range.

A common requirement for the formulator of agricultural products is to achieve acceptable stability, both in the sense of chemical stability, meaning that no significant chemical degradation occurs of the active ingredient, and also in the sense of physical stability, meaning that in commonly-available product containers stored in conditions commonly-encountered in the supply chain, the product remains in a state similar to that in which it was manufactured and the product is suitable and convenient for use by the end-user. Whether a particular active ingredient is susceptible to chemical degradation is not predictable because of the large number of factors that can determine its behavior. These include the solubility of the active ingredient in any liquid phases present (including the hydrophobic phases of any surfactant micellar structures), the presence within those liquid phases of chemical species that may catalyze degradation, any tendency for the active ingredient to undergo auto-catalysis whereby the breakdown products accelerate further reaction, the presence of chemical bonds within the active ingredient that are susceptible to cleavage and the influence of neighboring groups upon their susceptibility. Physical stability also must be assessed empirically, although it is known in the art that certain small-scale laboratory tests can often adequately represent behavior at larger scale in commercial use.

Amongst formulations tested during work described in the present disclosure, the inventors discovered that aqueous suspensions of (E)-3-methyl-N′-(1-(naphthalen-2-yl)ethylidene)benzohydrazide generally have unacceptable chemical stability. However, it was discovered that the oil flowable formulations described herein and containing the disclosed required components have adequate physical stability and remain suitable for use even when subjected to stress testing at elevated temperatures, including temperatures that might be experienced by a commercial product during transport, storage and use.

Disclosed herein are oil flowable formulations comprising a first active compound having a structure

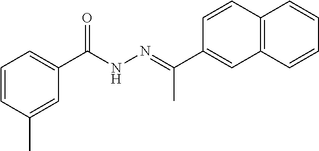 [SMILES: C/C(=N\NC(=O)c1cccc(C)c1)c1ccc2ccccc2c1]

### (E)-3-methyl-N′-(1-(naphthalen-2-yl)ethylidene)benzohydrazide

In some embodiments, the oil flowable formulation further comprises a lipophilic solvent, a first dispersant, and a rheology modifier. In some embodiments, the oil flowable formulation is an oil miscible concentrate, suitable for dilution, such as by an end user.

In some embodiments, the first active compound is present as a suspension in the formulation. The suspended particles may have a volume-weighted median particle size, as determined by light scattering, ranging from greater than 0.01 microns to 40 microns, such as from 0.01 microns to 30 microns, from 0.01 microns to 25 microns, such as from greater than 0.01 microns to 20 microns, from 0.01 microns to 15 microns, from 0.01 microns to 10 microns, such as from 0.1 microns to 5 microns, or from 0.5 microns to 2 microns. In certain embodiments, the volume-weighted median particle size is 1 micron. In certain other embodiments, the volume-weighted median particle size is 7.0 microns. In still other embodiments, the volume-weighted median particle size is 15 microns. Additionally, if the formulation includes additional suspended material, such as material disclosed herein, any such additional suspended material also may have a particle size, as measured by light scattering, as disclosed above for the first active compound.

### A. First Active Compound

The oil flowable formulation comprises the first active compound, (E)-3-methyl-N′-(1-(naphthalen-2-yl)ethylidene)benzohydrazide, in an amount sufficient that, when diluted for use, the first active compound is present in an amount sufficient to potentiate the efficacy of one or more agricultural active compounds that may be applied in combination with the first active compound. In some embodiments, the oil flowable formulation comprises from 5 wt % to 90 wt % of the first active compound, such as from 10 wt % to 90 wt %, from 20 wt % to 90 wt %, from 30 wt % to 85 wt %, from 30 wt % to 75 wt %, from 30 wt % to 65 wt %, 30 wt % to 50 wt %, or from 30 wt % to 40 wt % of the first active compound.

### B. Lipophilic Solvent

In some embodiments, the lipophilic solvent is or comprises mineral oil, a fatty acid, a vegetable or seed oil, a terpene, an aliphatic solvent, a cyclic hydrocarbon solvent, an aromatic solvent, or derivatives and/or combinations thereof. In certain embodiments, the lipophilic solvent is or comprises a fatty acid derivate, such as methyl oleate, methyl linolate, or a combination thereof, for example, Steposol® ME. In some embodiments, the lipophilic solvent is or comprises a paraffinic solvent, for example, Exxsol™ D80, Exxsol™ D110, or Exxsol™ D130 paraffinic solvent. In some embodiments, the lipophilic solvent is or comprises an aromatic solvent, for example, a Solvesso™ aromatic solvent, such as Solvesso™ 200 ND or Solvesso™ 150 ND. In some embodiments, the lipophilic solvent is or comprises tetrahydronaphthalene, alkylated naphthalenes, derivatives thereof, and/or combinations thereof.

In some embodiments, the lipophilic solvent is selected such that the first active compound is substantially insoluble in the lipophilic solvent. In some embodiments, the first active compound has a solubility in the lipophilic solvent under ambient conditions of below 2 wt %, such as from zero to 2 wt %, from zero to 1 wt %, or from zero to 0.1 wt % solubility in the lipophilic solvent. A person of ordinary skill in the art understands that solubility of a compound in organic solvents can be determined by routine techniques known to persons of ordinary skill in the art.

### C. Rheology Modifier

In some embodiments, the rheology modifier is or comprises an organo-modified clay, a silica or hydrophobically-modified silica, an alumina, a polyurethane-based polymer, or a combination thereof. In some embodiments, the rheology modifier is or comprises an organo-modified clay, such as hydrated aluminum magnesium silicate, for example, Attagel® 50. In some embodiments, the rheology modifier is or comprises a hydrophobically modified ethoxylated urethane copolymer, for example, Borchi® Gel 0434.

The rheology modifier is present in an amount suitable to provide a desired property, such as a particular viscosity. In some embodiments, the rheology modifier is present in the formulation in an amount of from 0.1 wt % to 15 wt %, such as from 1 wt % to 10 wt %.

### D. First Dispersant

The first dispersant may have a molecular weight of from 1,000 Daltons to 100,000 Daltons or more. In some embodiments, the first dispersant is fully soluble in the lipophilic solvent. In some embodiments, the first dispersant is or comprises a copolymer or a homo-polymer, or a combination thereof. The copolymer maybe a random or statistical copolymer, a block copolymer, a comb-structured block copolymer, or a combination thereof. Exemplary first dispersants include, but are not limited to, poly vinyl pyrrolidinone; a random copolymer of a combination of vinyl pyrrolidinone, stearyl methacrylate, lauryl methacrylate, and/or butyl methacrylate; a block copolymer of ethylene oxide and propylene oxide; or a combination thereof.

The first dispersant may be present in the formulation in an amount of from 0.1 wt % to 20 wt %, such as from 1 wt % to 10 wt %.

### E. Emulsifier

Optionally, the oil flowable formulation further comprises an emulsifier. The emulsifier may be an anionic surfactant, a cationic surfactant, a nonionic surfactant, a quaternary ammonium surfactant, a zwitterionic surfactant, or a combination thereof. In some embodiments, the surfactant is an anionic surfactant, a cationic surfactant, a nonionic surfactant, or a combination thereof. In any embodiments, the emulsifier may have a molecular weight of from 150 Daltons to 1,200 Daltons.

In any embodiments, the anionic surfactant is a citrate, carboxylate, phosphate, phosphonate, sulfate, or sulfonate. The anionic surfactant may be an ester of an alcohol, alcohol alkoxylate (for example, an alcohol ethoxylate and/or alcohol propoxylate), tristyryl phenol ethoxylate, fatty acid, natural oil, or a combination thereof. In other embodiments, the anionic surfactant may be a salt of a citrate, carboxylate, phosphate, phosphonate, sulfate, or sulfonate, such as a calcium salt, sodium salt, potassium salt, lithium salt, organic amine salt or ammonium salt.

In certain embodiments the organic amine salt is a salt of isopropylamine, butylamine, ethylamine, diethylamine, triethyleamine, diethanolamine, triethanolamine, methylamine, ethylene diamine, or a combination thereof.

In certain embodiments, the anionic surfactant is a citrate, carboxylate, phosphate, phosphonate, sulfate, or sulfonate ester of an alcohol, alcohol alkoxylate, tristyryl phenol ethoxylate, fatty acid, or natural oil, or any combination thereof. An exemplary anionic surfactant is Agnique® ABS 60 C-EH, which comprises calcium dodecylbenzene sulfonate.

The cationic surfactant may be an ethoxylated amine, such as an ethoxylated amine of a natural oil, alcohol, fatty acid, or a combination thereof.

In some embodiments, the formulation does not comprise more than 0.1 wt % of a compound comprising a primary amine, secondary amine, and/or tertiary amine, such as from zero to 0.1 wt % of such a compound, or zero wt % of such a compound. In some embodiments, the formulation does not comprise more than 0.1 wt % of a compound comprising a quaternary ammonium compound, such as from zero to 0.1 wt % of such a compound, or zero wt % of such a compound. In some such embodiments, the anionic surfactant may be a salt of a citrate, carboxylate, phosphate, phosphonate, sulfate, or sulfonate, such as a calcium salt, sodium salt, potassium salt, or lithium salt.

The nonionic surfactant may be an alkoxylate of an alcohol, natural oil, fatty alcohol, or a combination thereof, such as an ethoxylate and/or propoxylate of an alcohol, natural oil, fatty alcohol, or a combination thereof. An exemplary nonionic surfactant is Plurafac® LF 700 which is an alkoxylated fatty alcohol.

The quaternary ammonium surfactant may comprise at least one chain having at least 6 carbon atoms attached to the quaternary ammonium head group, such as from 6 to 20 carbon atoms, or from 6 to 12 carbon atoms.

And in some embodiments, the zwitterionic surfactant comprises a positively charged group, such as a quaternary ammonium group, and a negatively charged group, such as a carboxylic acid moiety, sulfonic acid moiety, or a phosphoric acid moiety. An example of a zwitterionic surfactant is cocamidopropyl betaine.

In other embodiments, the surfactant is a nonionic surfactant, and may be selected from an alkoxylate of an alcohol, natural oil, or a combination thereof.

Particularly with respect to surfactants disclosed herein, a person of ordinary skill in the art understands that an alkoxylate group (for example, ethoxylate or propoxylate) may include one or more than one alkoxy moiety (i.e., may be polyalkoxylated), such as from 1 to 200 or more alkoxy moieties. And in some embodiments, an alkoxylate group includes from more than one to 200 alkoxy groups, such as from 4 to 200, or from 4 to 150 alkoxy groups.

### F. Second Dispersant

Optionally, the oil flowable formulation further comprises a second dispersant. The second dispersant may be an anionic dispersant, a cationic dispersant, a non-ionic dispersant, or a combination thereof. The second dispersant may have a molecular weight of from 1,000 Daltons to 100,000 Daltons. In some embodiments, the second dispersant is soluble in water. In some embodiments, the second dispersant is or comprises a homo-polymeric dispersant, a random or statistical copolymer, a block copolymer, or a combination thereof. In some embodiments, the second dispersant is selected from polyacrylic acid, polyvinyl alcohol, polyvinyl pyrrolidone, polystyrene sulfonate, polyvinyl sulfonate, polyethyleneimine, polyethylene glycol/polyisobutylene succinic acid, vinylpyrrolidone/vinylcaprolactam, polyethyleneoxide/polypropyleneoxide, fatty acid/polyethyleneoxide, polyethoxylated alcohols, polyethoxylated diamines, naphthalene sulfonate formaldehyde condensate, lignosulfonate, ethoxylated lignosulfonate, or a combination thereof.

In certain embodiments, the second dispersant is an anionic dispersant.

In other embodiments, the second dispersant is a nonionic dispersant.

In some embodiments, the oil flowable formulation comprises both an emulsifier and a second dispersant.

### III. Agriculturally Active Compound

The disclosed formulation may further comprise an agriculturally active compound. Additionally, or alternatively, the formulation may be used in combination with one or more agriculturally active compounds, typically as part of an agricultural composition for application to a crop, seeds that may be sown to produce a crop, harvested produce, and/or soil into which a crop has been or may be planted or sown. The agricultural composition may be a diluted composition, formed, at least in part, by diluting the disclosed formulation with a suitable solvent or mixture of solvents, for example, water and/or a lipophilic solvent as described above.

Embodiments of the disclosed formulation are useful for enhancing the effect of a variety of agrochemicals, including fungicides, antiviral agents, bactericides, herbicides, insecticidal/acaricidal agents, molluscicides, nematicides, soil pesticides, plant control agents, synergistic agents, fertilizers and soil conditioners, such as a fungicide, pesticide, herbicide, insecticide, molluscicide, nematocide or a combination thereof.

In one embodiment, the presently disclosed formulation is useful for enhancing the fungicidal effect of a variety of fungicides. Fungicides for use with the disclosed formulation are well known to those of skill in the art and include, without limitation those set forth by class in Table 1:

TABLE 1

| Family & Group # | Common Names | Trade Names (Combination Products) |
|---|---|---|
| Benzimidazole (Group 1) | benomyl | Benlate, Tersan 1991 |
| | thiabendazole | Arbotect 20-S, Decco Salt No. 19, LSP Flowable |
| | | Fungicide, Mertect 340-F |
| | thiophanate-methyl | Cavalier, Cleary's 3336, OHP 6672, Regal |
| | | SysTec, Tee-Off, |
| | | T-Methyl 4.5F AG, TM 85, Topsin M |
| Dicarboximide (Group 2) | iprodione | Epic 30, Ipro, Meteor, Nevado, OHP Chipco |
| | | 26019, Rovral, (Interface) |
| | vinclozolin | Curalan, Ronilan |
| Phenylpyrroles (Group 12) | fludioxonil | Cannonball, Emblem, Maxim, Medallion, |
| | | Mozart, Scholar, Spirato, (Academy, Miravis |
| | | Prime, Palladium, Switch) |
| Anilinopyrimidines (Group | cyprodinil | Vangard (Palladium, Switch, Inspire Super) |
| 9) | pyrimethanil | Penbotec, Scala, (Luna Tranquility) |
| Hydroxyanilide (Group 17) | fenhexamid | Decree, Elevate, Judge |
| | fenpyrazamine | Protexio |
| Carboxamide (Group 7) | boscalid | Emerald, Endura, (Encartis, Honor, Pageant, |
| | | Pristine) |
| | carboxin | Vitavax |
| | fluopyram | Luna Privilege, Velum Prime (Broadform, Luna |
| | | Experience, Luna Sensation, Luna Tranquility, |
| | | Propulse) |
| | flutolanil | Contrast, Moncut, ProStar |
| | fluxapyroxad | (Lexicon, Merivon, Orkestra) |
| | inpyrfluxam | Excalia |
| | isofetamid | Kenja |
| | oxycarboxin | Carboject, Plantvax |
| | penthiopyrad | Fontelis, Velista, Vertisan |
| | pydiflumetofen | Miravis, Posterity, Miravis Ace A (Miravis Neo, |
| | | Miravis Prime, Miravis Duo, Miravis Top) |
| | solatenol | Aprovia (Contend A, Elatus, Mural) |
| | (benzovindiflupyr) | |
| Phenylamide (Group 4) | mefenoxam | Apron, Ridomil Gold, Subdue MAXX, (Quadris |
| | | Ridomil Gold, Uniform) |
| | metalaxyl | Acquire, Allegiance, MetaStar, Ridomil, |
| | | Sebring, Subdue |
| | oxadixyl | Anchor |
| Phosphonate (Group P7) | aluminum tris | Aliette, Flanker, Legion, Signature, Areca |
| | Phosphorous Acid | Agri-Fos, Alude, Appear, Fiata, Fosphite, |
| | | Phospho Jet, Phostrol, Rampart, Reload |
| Cinnamic acid (Group 40) | dimethomorph | Forum, Stature, (Orvego, Zampro) |
| | mandipropamid | Micora, Revus, (Revus Top) |
| OSBPI (Group 49) | oxathiapiprolin | Segovis |
| Triazoles carboxamide | ethaboxam | V-10208 |
| (Group 22) | | |
| Group 27 | cymoxanil | Curzate, (Tanos) |
| Carbamate (Group 28) | propamocarb | Banol, Previcur, Proplant, Tattoo |
| Benzamide (Group 43) | fluopicolide | Adorn, Presidio |

Demethylation-inhibiting (Group 3)

| | | |
|---|---|---|
| Piperazines | triforine | Funginex, Triforine |
| Pyrimidines | fenarimol | Focus, Rubigan, Vintage |
| Imidazole | imazalil | Fungaflor, (Raxil MD Extra) |
| | triflumizole | Procure, Terraguard, Trionic |
| Triazoles | cyproconizole | Sentinel |
| | difenoconazole | Dividend, Inspire, (Academy, Briskway, |
| | | Contend A, Inspire Super, Quadris Top, Revus |
| | | Top) Miravis Duo |
| | fenbuconazole | Enable, Indar |
| | flutriafol | Topguard, (Topguard EQ) |
| | mefentrifluconazole | Maxtima (Navicon) |
| | metconazole | Quash, Tourney |
| | ipconazole | Rancona |
| | myclobutanil | Eagle, Hoist, Immunox, Laredo, Nova, Rally, |
| | | Sonoma, Systhane |
| | propiconazole | Alamo, Banner, Break, Bumper, Infuse, Kestrel |
| | | Mex, Miravis Ace B, PropiMax, ProPensity, |
| | | Strider, Tilt, Topaz, (Aframe Plus, Concert, |
| | | Contend B, Headway, Quilt Xcel, Stratego) |
| | prothioconazole | Proline (Propulse) |
| | tebuconazole | Bayer Advanced, Elite, Folicur, Lynx, Mirage, |
| | | Orius, Raxil, Sativa, Tebucon, |
| | | Tebuject, Tebusha, Tebustar, Toledo, (Absolute, |
| | | Luna Experience, |
| | | Unicorn), etc. |
| | tetraconazole | Mettle |
| | triadimefon | Bayleton, Strike, (Armada, Tartan, Triigo) |
| | triadimenol | Baytan |
| | triticonazole | Charter, Trinity, (Pillar) |
| Morpholine (Group 5) | piperalin | Pipron |
| | spiroxamine | Accrue |
| Group U6 | cyflufenamid | Torino |
| Group 50 | metrafenone | Vivando |
| | pyriofenone | Prolivo |
| QoI Strobilurins (Group 11) | azoxystrobin | Abound, Aframe, Dynasty, Heritage, Protete, |
| | | Quadris, Quilt, (Aframe Plus, |
| | | Briskway, Contend B, Dexter Max, Elatus, |
| | | Headway, Mural, Quadris Top, |
| | | Quilt Xcel, Renown, Topguard EQ, Uniform) |
| | femoxadone | (Tanos) |
| | fenamidone | Fenstop, Reason |
| | fluoxastrobin | Aftershock, Disarm, Evito, Fame |
| | kresoxim-methyl | Cygnus, Sovran |
| | mandestrobin | Intuity, Pinpoint |
| | picoxystrobin | Aproach |
| | pyraclostrobin | Cabrio, Empress, Headline, Insignia, Stamina, |
| | | (Honor, Lexicon, Merivon, |
| | | Navicon, Orkestra, Pageant, Pillar, Pristine) |
| | trifloxystrobin | Compass, Flint, Gem, (Absolute, Armada, |
| | | Broadform, Interface, Luna Sensation, Stratego, |
| | | Tartan, Trigo) |
| Quinoline (Group 13) | quinoxyfen | Quintec |

Inorganic Compounds

| | | |
|---|---|---|
| Coppers (Group M1) | bordeaux | None |
| | copper ammonium | Copper Count-N |
| | complex | |
| | copper hydroxide | Champ, Champion, Kalmor, Kentan, Kocide, |
| | | Nu-Cop |
| | copper oxide | Nordox |
| | copper oxychloride | C-O-C-S, Oxycop |
| | copper sulfate | Cuprofix Disperss, many others |
| Sulfur (Group M2) | sulfur | Cosavet, Kumulus, Microthiol |
| | | Disperss, Thiosperse |
| Lime sulfur | Ca polysulfides | Lime Sulfur, Sulforix |
| Ethylenebisdithiocarbamates | mancozeb | Dithane, Fore, Penncozeb, Protect, Manex, |
| (EBDC) (Group M3) | | Manzate, Roper, Wingman, (Dexter Max, Gavel) |
| | maneb | Maneb |
| | metiram | Polyram |
| EBDC-like (Group M3) | ferbam | Carbamate, Ferbam |
| | thiram | Difiant, Spotrete, Thiram |
| | ziram | Ziram |
| Aromatic Hydrocarbon | dicloran (DCNA) | Allisan, Botran |
| (Group 14) | etridizole | Terrazole, Truban |
| | pentachloronitrobenzene | Autilus, Defend, Engage, PCNB, Terraclor, |
| | | (Premion) |
| Chloronitrile (Group M5) | chlorothalonil | Bravo, Daconil, Docket, Echo, Ensign, Exotherm |
| | | Termil, Funginil, Legend, |
| | | Manicure, Pegasus, Terranil, (Concert, Spectro) |
| Phthalimides (Group M4) | captan | Captan |
| Guanidines (Group U12) | dodine | Syllit |
| Qil fungicides (Group 21) | cyazofamid | Ranman, Segway |
| Polyoxin (Group 19) | polyoxin | Affirm, Endorse, Oso, Ph-D, Tavano, Veranda |
| Group 29 | fluazinam | Omega, Secure |
| Thiazolidine (U13) | flutianil | Gatten |

Fungicides are cataloged more broadly by the Pungicide Resistance Action Committee (FRAC) in the FRAC Code List 2022 and reproduced in Appendix 1 and which is incorporated herein by reference in its entirety.

In one embodiment, the disclosed formulation is used in combination with one or more compounds from the Families or Groups set forth in Table 1, Appendix 1, or both. In certain embodiments, the formulation is used in combination with one or more fungicides recited in column 1 of Table 1.

In particular embodiments, the disclosed formulation is used in combination with one or more of a fungicide selected from the benzimidazoles, dicarboximides, phenylpyrroles, anilinopyrimidines, hydroxyanilides, carboxamides, phenyl amides, phosphonates, cinnamic acids, oxysterol binding protein inhibitors (OSBPI), triazole carboxamides, cymoxanil, carbamates, benzamides, demethylation inhibiting piperazines, demethylation inhibiting pyrimidines, demethylation inhibiting azoles, including imidazoles, and triazoles, such as cyproconazole, difenoconazole, fenbuconazole, flutriafol, mefentrifluconazole, metconazole, ipconazole, prothioconazole, tebuconazole, tetraconazole, triadimefon, triadimenol, triticonazole, morpholines, cyflufenamid, metrafenone, pyriofenone, strobilurins, copper ammonium complex, copper hydroxide, copper oxide, copper oxychloride, copper sulfate, sulfur, lime sulfur, ethylenebisdithiocarbamates, aromatic hydrocarbons, phthalimides, guanidines, polyoxins, fluazinam and thiazolidines.

Particular fungicides that are potentiated by use in combination with the disclosed formulation according to the methods herein by administration of an apyrase inhibitor are coppers, such as copper octanoate, copper hydroxide, copper sulfate and the like, myclobutanil, propiconazole, tebuconazole, epoxiconazole, difenoconazole, triticonazole, and prothioconazole.

In one embodiment, the combined treatment with a selected fungicide and the disclosed formulation provides synergistic fungicidal activity against plant pathogenic fungi.

In one embodiment, the disclosure provides compositions and methods of treating plants or plant seeds infected with or at risk of being infected with a fungal pathogen. In one embodiment compositions of the present disclosure comprise a formulation of a fungicide, the disclosed formulation, and a phytologically acceptable carrier. In another embodiment, the fungicide and formulation are administered in separate compositions. In further embodiments, an agricultural or horticultural fungicide is used in combination with other compounds in addition to the disclosed formulation. Such other compounds can be administered in the same or separate compositions as the fungicide and/or formulation. Examples of the other components include known carriers to be used to conduct formulation. Additional examples thereof include conventionally-known herbicides, insecticidal/acaricidal agents, nematodes, soil pesticides, plant control agents, synergistic agents, fertilizers, soil conditioners, and animal feeds. In one embodiment, the inclusion of such other components yields synergistic effects on crop growth.

In one embodiment, the disclosed formulation is used to potentiate the effect of a herbicide. Exemplary herbicides for use in combination with the formulation are known to those of skill in the art and include, without limitation, those described in Appendix 2. By way of example, suitable herbicides for use in combination with the disclosed formulation include inhibitors of acetyl CoA synthase, inhibitors of acetolactate synthesis, inhibitors of microtubule assembly, inhibitors of microtubule organization, auxin mimics, photosynthesis inhibitors, deoxy-D-xylulose phosphate synthase inhibitors, enolpyruvyl shikimate phosphate synthase inhibitors, phytoene desaturase inhibitors, glutamine synthetase inhibitors, dihydropteroate synthesis inhibitors, protoporphyrinogen oxidase inhibitors, cellulose synthesis inhibitors, uncouplers, hydroxyphenyl pyruvate dioxygenase inhibitors, fatty acid thioesterase inhibitors, serine-threonine protein phosphatase inhibitors, solanesyl diphosphate synthase inhibitors, inhibitors of very long-chain fatty acid synthesis, homogentisate solanesyltransferase inhibitors, and/or lycopene cyclase inhibitors.

In one embodiment, the disclosed formulation is used to potentiate the effect of an insecticide. Exemplary insecticides for use in combination with the disclosed formulation are known to those of skill in the art and include, without limitation, those described in Appendix 3.

### IV. Method for Using the Formulation

Embodiments of a method for using the disclosed formulation comprise diluting the formulation in a suitable diluent, such as water and/or a lipophilic solvent, to form an agricultural composition suitable for application to a plant, part of a plant, a seed, soil where a plant is or will be growing, or soil where a seed has been or will be sown. The method may further comprise applying the agricultural composition to a plant, part of a plant, a seed, soil where a plant is or will be growing, or soil where a seed has been or will be sown.

In some embodiments, the disclosed formulation comprises one or more agriculturally active compounds and the agricultural composition is formed by diluting the formulation with a suitable solvent, such as water and/or a lipophilic solvent, to a concentration suitable for agricultural application. Optionally, one or more additional agriculturally active compounds may be added before, during and/or after dilution of the formulation.

In other embodiments, the formulation does not comprise an agriculturally active compound, and the agricultural composition is formed by diluting the formulation in a suitable solvent, such as water and/or a lipophilic solvent, with a concentration suitable for agricultural use. In such embodiments, forming the agricultural composition may further comprise adding one or more agriculturally active compounds, either to water and/or a lipophilic solvent before the formulation is added, concurrently while the formulation is diluted with water and/or a lipophilic solvent, and/or subsequently to a diluted mixture comprising the formulation.

In certain non-limiting embodiments, the disclosed formulation is diluted for agricultural application in an amount sufficient to provide the first active compound at: from 0.01 to 80% weight to weight in a final composition, or from 25% to 55%, such as from 30% to 50%, from 35% to 45%, such as 0.01, 0.05, 0.1, 0.5, 1.0, 1.1, 1.2, 1.3, 1.4, 1.5, 1.6, 1.7, 1.8, 1.9, 2.0, 2.5, 3.0, 4.0, 5.0, 7.5, 10, 20, 30, 40, 50, 55, 60 or 80% weight to weight in a final composition. In one embodiment the first active compound is provided at from 0.01 to 50%, such as from 15% to 50%, from 20% to 45%, from 25% to 40%, such as 0.01, 0.05, 0.1, 0.5, 1.0, 1.1, 1.2, 1.3, 1.4, 1.5, 1.6, 1.7, 1.8, 1.9, 2.0, 2.5, 3.0, 4.0, 5.0, 7.5, 10, 15, 20, 30, 40 or 50% volume to volume in a final diluted composition.

In some embodiments, the agriculturally active compound(s) is present in the agricultural composition at a concentration that is less than a concentration of the agriculturally active compound(s) that is recommended for use in the absence of the formulation disclosed herein, such as in the absence of (E)-3-methyl-N′-(1-(naphthalen-2-yl)ethylidene)benzohydrazide.

In some embodiments, a method of making the agricultural composition comprises adding the formulation disclosed herein to water and/or a lipophilic solvent in an amount sufficient to potentiate the agriculturally active compound(s), and adding the agriculturally active compound(s) in amounts sufficient to provide a concentration in the agricultural composition that is less than a concentration that is recommended for use in the absence of the disclosed formulation, such as in the absence of (E)-3-methyl-N′-(1-(naphthalen-2-yl)ethylidene)benzohydrazide. A person of ordinary skill in the art understands that the disclosed formulation and the agriculturally active compounds may be added to water and/or a lipophilic solvent sequentially in any order, or substantially simultaneously, to form the agricultural composition.

In any embodiments, the one or more agriculturally active compounds may be an agricultural or horticultural pesticide, such as an acaricide, antimicrobial, fungicide, herbicide, insecticide, molluscicide, or nematocide, or a combination thereof, as disclosed herein. In some embodiments, the method is a method for controlling or preventing fungal growth.

Crops that can be treated, include those plagued by various pathogens, including without limitation, bacteria, viruses, fungal pathogens, mites, nematodes, molluscs, weeds or other pests, as is known to those of ordinary skill in the agricultural arts. By way of example, such agricultural and horticultural crops that can be treated according to the present disclosure include plants, whether genetically modified or not, including their harvested products, such as: cereals; vegetables; root crops; potatoes; trees such as fruit trees, for example banana trees, tea, coffee trees, or cocoa trees; grasses; lawn grass; or cotton.

Agricultural compositions comprising the disclosed formulation may be applied to each part of plants, such as leaves, stems, patterns, flowers, buds, fruits, seeds, sprouts, roots, tubers, tuberous roots, shoots, or cuttings. The formulation may also be applied to improved varieties, cultivars, as well as mutants, hybrids and genetically modified embodiments of these plants.

Agricultural compositions comprising the disclosed formulation may be used to conduct seed treatment, foliage application, soil application, or water application, so as to control various diseases occurring in agricultural or horticultural crops, including flowers, lawns, and pastures.

Agricultural compositions comprising the disclosed formulation are useful for potentiating the effects of antimicrobial agents. For example, the disclosed formulation can be used in combination with an antimicrobial agent to combat bacterial and viral infection.

Embodiments of the disclosed formulation are useful for potentiating the effects of herbicides. For example, the disclosed formulation can be used in combination with one or more herbicide to control weeds or other unwanted vegetation.

Embodiments of the disclosed formulation are useful for potentiating the effects of insecticides. For example, the disclosed formulation can be used in combination with one or more insecticide to control insect infestation.

Embodiments of the disclosed formulation are useful for potentiating the effects of acaricides or miticides. For example, the disclosed formulation can be used in combination with one or more acaricidal agent to control mites.

Embodiments of the disclosed formulation are useful for potentiating the effects of molluscicides. For example, the disclosed formulation can be used in combination with one or more molluscicide to prevent interference of slugs or snails with a crop.

Embodiments of the disclosed formulation are useful for potentiating the effects of nematocides. For example, the disclosed formulation can be used in combination with one or more nematocide to prevent interference of nematodes with a crop.

Embodiments of the disclosed formulation are particularly useful for potentiating the effects of fungicides against plant fungal pathogens. Examples of pathogens treated according to the present disclosure include, without limitation, Botrytis cinerea, Colletotrichum graminicola, Fusarium oxysporum, Sclerotiana sclerotiorum, Verticillium dahlia, Mycospharella gramincola and Sphacelotheca reliana.

Botrytis cinerea is an airborne plant pathogen with a necrotrophic lifestyle attacking over 200 crop hosts worldwide. It mainly attacks dicotyledonous plant species, including important protein, oil, fiber and horticultural crops, grapes and strawberries and also Botrytis also causes secondary soft rot of fruits and vegetables during storage, transit and at the market. Many classes of fungicides have failed to control Botrytis cinerea due to its genetic plasticity.

The genus Colletotrichum comprises about 600 species attacking over 3,200 species of monocot and dicot plants. Colletotrichum graminicola primarily infects maize (Zea mays), causing annual losses of approximately 1 billion dollars in the United States alone (Connell et al., 2012).

Fusarium wilt of banana, caused by the soil-borne fungus Fusarium oxysporum f.sp. cubense, is a major threat to banana production worldwide. No fungicides are currently available to effectively control the disease once plants are infected (Peng J et al., 2014).

The white mold fungus Sclerotinia sclerotiorum is known to attack more than 400 host species and is considered one of the most prolific plant pathogens. The majority of the affected crop species are dicotyledonous, along with a number of agriculturally significant monocotyledonous plants. Some important crops affected by S. sclerotiorum include legumes (soybean), most vegetables, stone fruits and tobacco.

The ascomycete Verticillium dahliae is a soil-borne fungal plant pathogen that causes vascular wilt diseases in a broad range of dicotyledonous host species. V. dahliae can cause severe yield and quality losses in cotton and other important crops such as vegetables, fibers, fruit, nut trees, forest trees and ornamental plants.

The ascomycete fungus Mycospharella gramincola (anamorph: Septoria tritici) is one of the most important foliar diseases of wheat leaves, occurring wherever wheat is grown. Yield losses attributed to this disease range from 25%-50%, and are especially high in Europe, the Mediterranean region and East Africa. Infection by M. gramincola is initiated by air borne ascospores produced on residues of last season's crop. Primary infection usually occurs after seedlings emerge in spring or fall. The mature disease is characterized by necrotic lesions on the leaves and stems of infected plants.

The basidiomycete fungus Sphacelotheca reliana infects corn (Zea mays) systemically, causing Head Smut. Yield loss attributed to the disease is variable, and is directly dependent on the incidence of the disease. The fungus overwinters as diploid teliospores in crop debris or soil. Floral structures are converted to sori containing masses of powdery teliospores that resemble mature galls of common smut.

Examples of crops to be treated and plant diseases (pathogens) to be controlled using the presently disclosed compounds and compositions include, without limitation:

Sugar beet: brown spot disease (Cercospora beticola), black root disease (Aphanomyces cochlioides), root rot disease (Thanatephorus cucumeris), leaf rot disease (Thanatephorus cucumeris), and the like.

Peanut: brown spot disease (Mycosphaerella arachidis), leaf mold (Ascochyta sp.), rust disease (Puccinia arachidis), damping-off disease (Pythium debaryanum), rust spot disease (Alternaria alternata), stem rot disease (Sclerotium rolfsii), black rust disease (Mycosphaerella berkeleyi), and the like.

Cucumber: powdery mildew (Sphaerotheca fuliginea), downy mildew (Pseudoperonospora cubensis), gummy stem blight (Mycosphaerella melonis), wilt disease (Fusarium oxysporum), sclerotinia rot (Sclerotinia sclerotiorum), gray mold (Botrytis cinerea), anthracnose (Colletotrichum orbiculare), scab (Cladosporium cucumerinum), brown spot disease (Corynespora cassiicola), damping-off disease (Pythium debaryanum, Rhizoctonia solani Kuhn), Phomopsis root rot disease (Phomopsis sp.), Bacterial spot (Pseudomonas syringae pv. Lechrymans), and the like.

Tomato: gray mold disease (Botrytis cinerea), leaf mold disease (Cladosporium fulvum), late blight disease (Phytophthora infestans), Verticillium wilt disease (Verticillium albo-atrum, Verticillium dahliae), powdery mildew disease (Oidium neolycopersici), early blight disease (Alternaria solani), leaf mold disease (Pseudocercospora fuligena), and the like.

Eggplant: gray mold disease (Botrytis cinerea), black rot disease (Corynespora melongenae), powdery mildew disease (Erysiphe cichoracearum), leaf mold disease (Mycovellosiella nattrassii), sclerotinia rot disease (Sclerotinia sclerotiorum), Verticillium wilt disease (Verticillium dahlia), Mycosphaerella blight (Phomopsis vexans), and the like.

Strawberry: gray mold disease (Botrytis cinerea), powdery mildew disease (Sphaerotheca humuli), anthracnose disease (Colletotrichum acutatum, Colletotrichum fragariae), phytophthora rot disease (Phytophthora cactorum), soft rot disease (Rhizopus stolonifer), fusarium wilt disease (Fusarium oxysporum), verticillium wilt disease (Verticillium dahlia), and the like.

Onion: neck rot disease (Botrytis allii), gray mold disease (Botrytis cinerea), leaf blight disease (Botrytis squamosa), downy mildew disease (Peronospora destructor), Phytophthora porn disease (Phytophthora porn), and the like.

Cabbage: clubroot disease (Plasmodiophora brassicae), soft rot disease (Erwinia carotovora), black rot disease (Xanthomonas campesrtis pv. Campestris), bacterial black spot disease (Pseudomonas syringae pv. Maculicola, P.s. pv. Alisalensis), downy mildew disease (Peronospora parasitica), sclerotinia rot disease (Sclerotinia sclerotiorum), black spot disease (Alternaria brassicicola), gray mold disease (Botrytis cinerea), and the like.

Common bean: sclerotinia rot disease (Sclerotinia sclerotiorum), gray mold disease (Botrytis cinerea), anthracnose (Colletotrichum lindemuthianum), angular spot disease (Phaeoisariopsis griseola), and the like.

Apple: powdery mildew disease (Podosphaera leucotricha), scab disease (Venturia inaequalis), Monilinia disease (Monilinia mali), black spot disease (Mycosphaerella pomi), valla canker disease (Valsa mali), alternaria blotch disease (Alternaria mali), rust disease (Gymnosporangium yamadae), ring rot disease (Botryosphaeria berengeriana), anthracnose disease (Glomerella cingulata, Colletotrichum acutatum), leaf rot disease (Diplocarpon mali), fly speck disease (Zygophiala jamaicensis), Sooty blotch (Gloeodes pomigena), violet root rot disease (Helicobasidium mompa), gray mold disease (Botrytis cinerea), and the like.

Japanese apricot: scab disease (Cladosporium carpophilum), gray mold disease (Botrytis cinerea), brown rot disease (Monilinia mumecola), and the like.

Persimmon: powdery mildew disease (Phyllactinia kakicola), anthracnose disease (Gloeosporium kaki), angular leaf spot (Cercospora kaki), and the like.

Peach: brown rot disease (Monilinia fructicola), scab disease (Cladosporium carpophilum), phomopsis rot disease (Phomopsis sp.), bacterial shot hole disease (Xanthomonas campestris pv. Pruni), and the like.

Almond: brown rot disease (Monilinia taxa), spot blotch disease (Stigmina carpophila), scab disease (Cladosporium carpophilum), red leaf spot disease (Polystigma rubrum), alternaria blotch disease (Alternaria alternata), anthracnose (Colletotrichum gloeospoides), and the like.

Yellow peach: brown rot disease (Monilinia fructicola), anthracnose disease (Colletotrichum acutatum), black spot disease (Alternaria sp.), Monilinia kusanoi disease (Monilinia kusanoi), and the like.

Grape: gray mold disease (Botrytis cinerea), powdery mildew disease (Uncinula necator), ripe rot disease (Glomerella cingulata, Colletotrichum acutatum), downy mildew disease (Plasmopara viticola), anthracnose disease (Elsinoe ampelina), brown spot disease (Pseudocercospora vitis), black rot disease (Guignardia bidwellii), white rot disease (Coniella castaneicola), rust disease (Phakopsora ampelopsidis), and the like.

Pear: scab disease (Venturia nashicola), rust disease (Gymnosporangium asiaticum), black spot disease (Alternaria kikuchiana), ring rot disease (Botryosphaeria berengeriana), powdery mildew disease (Phyllactinia mali), Cytospora canker disease (Phomopsis fukushii), brown spot blotch disease (Stemphylium vesicarium), anthracnose disease (Glomerella cingulata), and the like.

Tea: ring spot disease (Pestalotiopsis longiseta, P. theae), anthracnose disease (Colletotrichum theae-sinensis), Net blister blight (Exobasidium reticulatum), and the like.

Citrus fruits: scab disease (Elsinoe fawcettii), blue mold disease (Penicillium italicum), common green mold disease (Penicillium digitatum), gray mold disease (Botrytis cinerea), melanose disease (Diaporthe citri), canker disease (Xanthomonas campestris pv. Citri), powdery mildew disease (Oidium sp.), and the like.

Wheat: powdery mildew (Blumeria graminis f. sp. Tritici), red mold disease (Gibberella zeae), red rust disease (Puccinia recondita), brown snow mold disease (Pythium iwayamai), pink snow mold disease (Monographella nivalis), eye spot disease (Pseudocercosporella herpotrichoides), leaf scorch disease (Septoria tritici), glume blotch disease (Leptosphaeria nodorum), typhula snow blight disease (Typhula incarnata), sclerotinia snow blight disease (Myriosclerotinia borealis), damping-off disease (Gaeumannomyces graminis), ergot disease (Claviceps purpurea), stinking smut disease (Tilletia caries), loose smut disease (Ustilago nuda), and the like.

Barley: leaf spot disease (Pyrenophora graminea), net blotch disease (Pyrenophora teres), leaf blotch disease (Rhynchosporium secalis), loose smut disease (Ustilago tritici, U. nuda), and the like.

Rice: blast disease (Pyricularia oryzae), sheath blight disease (Rhizoctonia solani), bakanae disease (Gibberella fujikuroi), brown spot disease (Cochliobolus miyabeanus), damping-off disease (Pythium graminicola), bacterial leaf blight (Xanthomonas oryzae), bacterial seedling blight disease (Burkholderia plantarii), brown stripe disease (Acidovorax avenae), bacterial grain rot disease (Burkholderia glumae), Cercospora leaf spot disease (Cercospora oryzae), false smut disease (Ustilaginoidea virens), rice brown spot disease (Alternaria alternata, Curvularia intermedia), kernel discoloration of rice (Alternaria padwickii), pink coloring of rice grains (Epicoccum purpurascens), and the like.

Tobacco: sclerotinia rot disease (Sclerotinia sclerotiorum), powdery mildew disease (Erysiphe cichoracearum), phytophthora rot disease (Phytophthora nicotianae), and the like.

Tulip: gray mold disease (Botrytis cinerea), and the like.

Sunflower: downy mildew disease (Plasmopara halstedii), sclerotinia rot disease (Sclerotinia sclerotiorum), and the like.

Bent grass: Sclerotinia snow blight (Sclerotinia borealis), Large patch (Rhizoctonia solani), Brown patch (Rhizoctonia solani), Dollar spot (Sclerotinia homoeocarpa), blast disease (Pyricularia sp.), Pythium red blight disease (Pythium aphanidermatum), anthracnose disease (Colletotrichum graminicola), and the like.

Orchard grass: powdery mildew disease (Erysiphe graminis), and the like.

Soybean: purple stain disease (Cercospora kikuchii), downy mildew disease (Peronospora manshurica), phytophthora rot disease (Phytophthora sojae), rust disease (Phakopsora pachyrhizi), sclerotinia rot disease (Sclerotinia sclerotiorum), anthracnose disease (Colletotrichum truncatum), gray mold disease (Botrytis cinerea), Sphaceloma scab (Elsinoe glycines), melanoses (Diaporthe phaseolorum var. sojae), and the like.

Potato: hytophthora rot disease (Phytophthora infestans), early blight disease (Alternaria solani), scurf disease (Thanatephorus cucumeris), verticillium wilt disease (Verticillium albo-atrum, V. dahlia, V. nigrescens, and the like.

Banana: Panama disease (Fusarium oxysporum), Sigatoka disease (Mycosphaerella fijiensis, M. musicola), and the like.

Rapeseed: sclerotinia rot disease (Sclerotinia sclerotiorum), root rot disease (Phoma lingam), black leaf spot disease (Alternaria brassicae), and the like.

Coffee: rust disease (Hemileia vastatrix), anthracnose (Colletotrichum coffeanum), leaf spot disease (Cercospora coffeicola), and the like.

Sugarcane: brown rust disease (Puccinia melanocephala), and the like.

Corn: zonate spot disease (Gloeocercospora sorghi), rust disease (Puccinia sorghi), southern rust disease (Puccinia polysora), smut disease (Ustilago maydis), brown spot disease (Cochliobolus heterostrophus), northern leaf blight (Setosphaeria turcica), and the like.

Cotton: seedling blight disease (Pythium sp.), rust disease (Phakopsora gossypii), sour rot disease (Mycosphaerella areola), anthracnose (Glomerella gossypii), and the like.

### V. Method for Making the Formulation

The disclosed formulation can be made by methods known to persons of ordinary skill in the art. In some embodiments, the method comprises providing the first active compound, the lipophilic solvent, the dispersant, and the rheology modifier, and forming the formulation. Optionally, an emulsifier, a second dispersant, and/or an agriculturally active compound also may be added. In some embodiments, the first active compound is first milled, such as by stirring with beads, to a desired particle size, such as a median particle size of less than 2 microns, and used to form the formulation. In some embodiments, the milled first active compound is added to a mixture comprising the lipophilic solvent, the first dispersant, and the rheology modifier. In other embodiments, the milled first active compound is added to one or more of the lipophilic solvent, the first dispersant, and the rheology modifier, and the remaining components are added subsequently or simultaneously.

In any embodiments, any optional components, such as an emulsifier and/or a second dispersant, and any agriculturally active compound(s), may be added at any suitable stage during the formation of the formulation.

In other embodiments, the first active compound is added to one or more of the lipophilic solvent, the first dispersant, and the rheology modifier, and then is milled, such as by stirring with beads, to the desired size before any remaining components are added. If the optional emulsifier and/or second dispersant are required, they can be added before the first active is milled, after milling, or during milling. Similarly, any agriculturally active compound(s) may be added at any suitable stage during the formation of the formulation.

In any embodiments, a mixture comprising the rheology modifier may be subjected to high shear to active activate the rheology modifier. The mixture may be exposed to the high shear at any suitable stage during the formation of the formulation, as understood by a person of ordinary skill in the art.

### VI. Certain Embodiments

The present disclosure contemplates, among other things, the following numbered embodiments:
1. A composition, comprising:
a compound having a structure

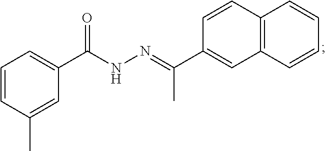 [SMILES: C/C(=N\NC(=O)c1cccc(C)c1)c1ccc2ccccc2c1]

a lipophilic solvent;
a first dispersant; and
a rheology modifier.
2. The composition of embodiment 1, wherein the compound is substantially insoluble in the lipophilic solvent.
3. The composition of embodiment 1 or embodiment 2, wherein the compound is present in the form of particles having a volume-weighted median particle size ranging from greater than 0.01 microns to 20 microns.
4. The composition of embodiment 3, wherein the volume-weighted median particle size is from 0.1 microns to 5 microns.
5. The composition of embodiment 1, wherein the volume-weighted median particle size of the compound, as measured by light scattering, is less than about 15 microns.
6. The formulation of embodiment 1, wherein the volume-weighted median particle size of the compound, as measured by light scattering, is less than about 7 microns.
7. The composition of embodiment 3, wherein the volume-weighted median particle size is from 0.5 microns to 2 microns.
8. The formulation of embodiment 1, wherein the volume-weighted median particle size of the compound, as measured by light scattering, is about 1 micron or less.
9. The composition of any one of embodiments 1-8, wherein the lipophilic solvent comprises mineral oil, a fatty acid, a vegetable or seed oil, a terpene, an aliphatic solvent, a cyclic hydrocarbon solvent, an aromatic solvent, or derivatives and/or combinations thereof.
10. The composition of embodiment 9, wherein the lipophilic solvent comprises a fatty acid derivative.
11. The composition of embodiment 10, wherein the fatty acid derivative is selected from fatty acid esters, fatty acid dialkyl amides and combinations thereof.
12. The composition of embodiment 10, wherein the fatty acid derivative comprises methyl oleate.
13. The composition of embodiment 9, wherein the lipophilic solvent comprises a paraffinic solvent.
14. The composition of embodiment 9, wherein the lipophilic solvent comprises an aromatic solvent.
15. The composition of embodiment 9, wherein the lipophilic solvent comprises tetrahydronaphthalene, alkylated naphthalenes, derivatives thereof, or combinations thereof.
16. The composition of any one of embodiments 3-8, wherein the particles are present in an amount from 5 wt % to 90 wt %.
17. The composition of any one of embodiments 3-8, wherein the particles are present in an amount from 30 wt % to 85 wt %.
18. The composition of any one of embodiments 3-8, wherein the particles are present in an amount from 30 wt % to 50 wt %.
19. The composition of any one of embodiments 1-18, wherein the rheology modifier comprises an organo-modified clay, a silica or hydrophobically-modified silica, an alumina, a polyurethane-based polymer, or a combination thereof.
20. The composition of any one of embodiments 1-19, wherein the rheology modifier is present in an amount of from 0.1 wt % to 15 wt %.
21. The composition of embodiment 20, wherein the rheology modifier is present in an amount of from 1 wt % to 10 wt %.
22. The composition of any one of embodiments 1-21, wherein the first dispersant has a molecular weight of from 1,000 Daltons to 100,000 Daltons and is fully soluble in the lipophilic solvent.
23. The composition of any one of embodiments 1-22, wherein the first dispersant is an anionic dispersant, a cationic dispersant, a non-ionic dispersant, or a combination thereof.
24. The composition of any one of embodiments 1-23, wherein the first dispersant is an anionic dispersant.
25. The composition of any one of embodiments 1-23, wherein the first dispersant is a nonionic dispersant.
26. The composition of any one of embodiments 1-25, wherein the first dispersant is selected from a homo-polymeric dispersant, a random or statistical copolymer, a block copolymer, or a combination thereof.
27. The composition of any one of embodiments 1-25, wherein the first dispersant is a copolymer.
28. The composition of embodiment 27, wherein the copolymer is a random or statistical copolymer, a block copolymer, a comb-structured block copolymer, or a combination thereof.
29. The composition of any one of embodiments 1-26, wherein the first dispersant is selected from polyacrylic acid, polyvinyl alcohol, polyvinyl pyrrolidone, polystyrene sulfonate, polyvinyl sulfonate, polyethyleneimine, polyethylene glycol/polyisobutylene succinic acid, vinylpyrrolidone/vinylcaprolactam, polyethyleneoxide/polypropyleneoxide, fatty acid/polyethyleneoxide, polyethoxylated alcohols, polyethoxylated diamines, naphthalene sulfonate formaldehyde condensate, lignosulfonate, ethoxylated lignosulfonate, or a combination thereof.
30. The composition of any one of embodiments 1-29, wherein the first dispersant is present in an amount of from 0.1 wt % to 20 wt %.
31. The composition of embodiment 30, wherein the first dispersant is present in an amount of from 1 wt % to 10 wt %.
32. The composition of any one of embodiments 1-31, further comprising an emulsifier and a second dispersant.
33. The composition of embodiment 32, wherein the emulsifier has a molecular weight of from 150 Daltons to 1,200 Daltons.
34. The composition of embodiment 32 or embodiment 33, wherein the emulsifier is an anionic surfactant, a cationic surfactant, a nonionic surfactant, a quaternary ammonium surfactant, a zwitterionic surfactant, or a combination thereof.
35. The composition of embodiment 34, wherein the emulsifier is selected from an anionic surfactant, cationic surfactant, nonionic surfactant, or a combination thereof.
36. The composition of embodiment 34 or embodiment 35, wherein:
the anionic surfactant is a citrate, carboxylate, phosphate, phosphonate, sulfate, or sulfonate ester of an alcohol, alcohol ethoxylate, tristyryl phenol ethoxylate, fatty acid, or natural oil, or any combination thereof;
the cationic surfactant is an ethoxylated amine of a natural oil, alcohol, fatty acid, or a combination thereof; or
the nonionic surfactant is a polyethoxylated and/or polypropoxylate of an alcohol, natural oil, or a combination thereof.
37. The composition of any one of embodiments 1-36, wherein the composition does not comprise more than 0.1 wt % of a compound comprising a primary amine, secondary amine, and/or tertiary amine.
38. The composition of any one of embodiments 1-37, wherein the composition does not comprise more than 0.1 wt % of a quaternary ammonium compound.
39. The composition of any one of embodiments 32-38, wherein the second dispersant has a molecular weight of from 1,000 Daltons to 100,000 Daltons and is soluble in water.
40. The composition of any one of embodiments 1-39, further comprising an agriculturally active compound A.
41. An agricultural composition, comprising water and/or a lipophilic solvent and the composition of any one of embodiments 1-40.
42. The agricultural composition of embodiment 41, wherein the agricultural composition comprises from 0.01 wt % to 10 wt % of the composition of any one of embodiments 1-40.
43. The agricultural composition of embodiment 41 or embodiment 42, wherein the agricultural composition further comprises an agriculturally active compound B.
44. The composition of embodiment 40, or the agricultural composition of any one of embodiments 38-39, wherein the composition or agricultural composition comprises at least one of agriculturally active compound A or agriculturally active compound B, and each of agriculturally active compound A and agriculturally active compound B independently is an acaricide, antimicrobial, fungicide, herbicide, insecticide, molluscicide, or nematocide, or a combination thereof.
45. The composition or agricultural composition of embodiment 44, wherein each of agriculturally active compound A and agriculturally active compound B independently is a fungicide.
46. The composition or agricultural composition of embodiment 44, wherein each of agriculturally active compound A and agriculturally active compound B independently is a fungicide selected from a benzimidazole fungicide, dicarboximide fungicide, phenylpyrrole fungicide, anilinopyrimidine fungicide, hydroxyanilide fungicide, carboxamide fungicide, phenylamide fungicide, phosphonate fungicide, cinnamic acid fungicide, OSBPI fungicide, triazole carboxamide fungicide, Group 27 fungicide, carbamate fungicide, benzamide fungicide, demethylation-inhibiting fungicide, piperazine fungicide, pyrimidine fungicide imidazole fungicide, triazole fungicide, morpholine fungicide, Group U6 fungicide, Group 50 fungicide, QoI strobilurin fungicide, quinoline fungicide, inorganic fungicide, copper fungicide, sulfur fungicide, lime sulfur fungicide, ethylenebisdithiocarbamate (EBDC) fungicide, EBDC-like fungicide, aromatic hydrocarbon fungicide, chloronitrile fungicide, phthalimide fungicide, guanidine fungicide, QiI fungicide, polyoxin fungicide, Group 29 fungicide, thiazolidine fungicide, or a combination thereof.
47. The composition or agricultural composition of embodiment 44, wherein each of agriculturally active compound A and agriculturally active compound B independently is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.
48. A method of using the agricultural composition of any one of embodiments 41-47, applying the agricultural composition to a plant, a part of a plant, a seed, soil where a plant is or will be growing, or soil where a seed has been or will be sown.
49. A method for controlling or preventing fungal growth comprising applying the agricultural composition of any one of embodiments 41-47 to a site that has a fungal growth or that is at risk of developing a fungal growth.
50. A method for controlling or preventing fungal growth comprising:
diluting the composition of any one of embodiments 1-40 or embodiments 44-47 with water and/or a lipophilic solvent to form a diluted mixture; and
applying the diluted mixture to a site that has a fungal growth or that is at risk of developing a fungal growth.
51. The method of embodiment 50, wherein the composition is a composition according to any one of embodiments 1-39, and diluting the composition further comprises adding an agriculturally active compound.
52. The method of embodiment 50, wherein adding the agriculturally active compound comprises adding an amount of the agriculturally active compound that is less than an amount of the agriculturally active compound that is recommended for use in the absence of the composition of any one of embodiments 1-39.
53. The method of any one of embodiments 51-52, wherein the agriculturally active compound is a fungicide selected from a benzimidazole fungicide, dicarboximide fungicide, phenylpyrrole fungicide, anilinopyrimidine fungicide, hydroxyanilide fungicide, carboxamide fungicide, phenylamide fungicide, phosphonate fungicide, cinnamic acid fungicide, OSBPI fungicide, triazole carboxamide fungicide, Group 27 fungicide, carbamate fungicide, benzamide fungicide, demethylation-inhibiting fungicide, piperazine fungicide, pyrimidine fungicide imidazole fungicide, triazole fungicide, morpholine fungicide, Group U6 fungicide, Group 50 fungicide, QoI strobilurin fungicide, quinoline fungicide, inorganic fungicide, copper fungicide, sulfur fungicide, lime sulfur fungicide, ethylenebisdithiocarbamate (EBDC) fungicide, EBDC-like fungicide, aromatic hydrocarbon fungicide, chloronitrile fungicide, phthalimide fungicide, guanidine fungicide, QiI fungicide, polyoxin fungicide, Group 29 fungicide, thiazolidine fungicide, or a combination thereof.
54. The method of any one of embodiments 51-42 wherein the agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.
55. A use of an agricultural composition of any one of embodiments 41-47, for administration to a plant, part of a plant, a seed, soil where a plant is or will be growing, or soil where a seed has been or will be sown.
56. A use of an agricultural composition of any one of embodiments 41-47, for controlling or preventing fungal growth at a site that has a fungal growth or that is at risk of developing a fungal growth.

### VII. Examples

### Example 1

An oil flowable formulation is prepared as follows: 2 g of Luvitec® K30 (poly vinyl pyrrolidinone) is dissolved in 53 g of Exxsol® D80 paraffinic solvent. 5 g of Attagel® 50 rheology modifier and the mixture is subjected to high shear to activate the rheology modifier.

Into this mixture is dispersed 40 g of (E)-3-methyl-N′-(1-(naphthalen-2-yl)ethylidene)benzohydrazide that has previously been air-milled such that it has a median particle size below 2 microns. The oil flowable formulation is expected to have excellent chemical and physical stability.

### Example 2

An oil dispersible formulation is prepared as follows: 2 g of Luvitec K30 is dissolved in 46 g of Steposol™ ME (methyl oleate/linolate). 5 g of Borchi® Gel 0434 rheology modifier is added, together with emulsifiers 3 g Plurafac® LF 700, 4 g Agnique® ABS 60 C-EH.

Into this mixture is dispersed 40 g (E)-3-methyl-N′-(1-(naphthalen-2-yl)ethylidene)benzohydrazide that has previously been air-milled such that it has a median particle size below 2 microns. The oil dispersible formulation is expected to have excellent chemical and physical stability.

### Example 3

### Chemical Stability

Samples are prepared according to the method described herein, such as in Example 1 above, except that to particular sub-samples are added low concentrations of certain components including a primary amine, a secondary amine, a tertiary amine, or a quaternary amine. The samples are assessed for chemical stability by storing them at elevated temperatures and by periodically measuring the remaining concentration of the active ingredient by HPLC. Reference samples are stored at low temperature and also tested at the same time points. It is expected that certain components accelerate chemical degradation and must be excluded from formulations of the present invention.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

APPENDIX 1

| | | | CHEMICAL OR | | | |
|---|---|---|---|---|---|---|
| | TARGET SITE | GROUP | BIOLOGICAL | COMMON | | FRAC |
| MOA | AND CODE | NAME | GROUP | NAME | COMMENTS | CODE |
| A: | A1 | PA - fungicides | acylalanines | benalaxyl | Resistance and cross | 4 |
| nucleic acids | RNA polymerase I | (PhenylAmides) | | benalaxyl-M | resistance well | |
| metabolism | | | | (=kiralaxyl) | known in various | |
| | | | | furalaxyl | Oomycetes but mechanism | |
| | | | | metalaxyl | unknown. | |
| | | | | metalaxyl-M | High risk. | |
| | | | | (=mefenoxam) | See FRAC Phenylamide | |
| | | | oxazolidinones | oxadixyl | Guidelines for resistance | |
| | | | butyrolactones | ofurace | management | |
| | A2 | hydroxy- | hydroxy- | bupirimate | Medium risk. Resistance and | 8 |
| | adenosin- | (2-amino-) | (2-amino-) | dimethirimol | cross resistance known in | |
| | deaminase | pyrimidines | pyrimidines | ethirimol | powdery mildews. | |
| | | | | | Resistance management | |
| | | | | | required. | |
| | A3 | heteroaromatics | isoxazoles | hymexazole | Resistance not known. | 32 |
| | DNA/RNA synthesis | | isothiazolones | octhilinone | | |
| | (proposed) | | | | | |
| | A4 | carboxylic acids | carboxylic acids | oxolinic acid | Bactericide. | 31 |
| | DNA topoisomerase | | | | Resistance known. | |
| | type II (gyrase) | | | | Risk in fungi unknown. | |
| | | | | | Resistance management | |
| | | | | | required. | |
| | A5 | DHODHI- | phenyl-propanol | ipflufenoquin | Medium to high risk. | 52 |
| | inhibition of | fungicides | | | | |
| | dihydroorotate | | | | | |
| | dehydrogenase | | | | | |
| | within de novo | | | | | |
| | pyrimidine | | | | | |
| | biosynthesis | | | | | |
| B: | B1 | MBC - | benzimidazoles | benomyl | Resistance common in many | 1 |
| Cytoskeleton | tubulin | fungicides | | carbendazim | fungal species. Several target | |
| and motor | polymerization | (Methyl | | fuberidazole | site mutations, mostly | |
| protein | | Benzimidazole | | thiabendazole | E198A/G/K, F200Y in | |
| | | Carbamates) | thiophanates | thiophanate | β-tubulin gene. | |
| | | | | thiophanate- | Positive cross resistance | |
| | | | | methy [symbol] | between the group members. | |
| | | | | | Negative cross resistance to | |
| | | | | | N-phenyl carbamates. | |
| | | | | | High risk. | |
| | | | | | See FRAC Benzimidazole | |
| | | | | | Guidelines for resistance | |
| | | | | | management. | |
| | B2 | N-phenyl | N-phenyl | diethofencarb | Resistance known. Target site | 10 |
| | tubulin | carbamates | carbamates | | mutation E198K. Negative | |
| | polymerization | | | | cross resistance to | |
| | | | | | benzimidazoles. | |
| | | | | | High risk. | |
| | | | | | Resistance management | |
| | | | | | required. | |
| | B3 | benzamides | toluamides | zoxamide | Low to medium risk. | 22 |
| | tubulin | thiazole | ethylamino-thiazole- | ethaboxam | Resistance management | |
| | polymerization | carboxamide | carboxamide | | required. | |
| | B4 | phenylureas | phenylureas | pencycuron | Resistance not known. | 20 |
| | cell division | | | | | |
| | (unknown site) | | | | | |
| | B5 | benzamides | pyridinylmethyl- | fluopicolide | Resistant isolates detected in | 43 |
| | delocalisation of | | benzamides | fluopimomide | grapevine downy mildew. | |
| | spectrin-like | | | | Medium risk. | |
| | proteins | | | | Resistance management | |
| | | | | | required | |
| | B6 | cyanoacrylates | aminocyanoacrylates | phenamacril | Resistance known in | 47 |
| | actin/myosin/fimbrin | | | | Fusarium | |
| | function | | | | graminearum. | |
| | | | | | Target site mutations in the | |
| | | | | | gene coding for myosin-5 | |
| | | | | | found in lab studies. | |
| | | | | | Medium to high risk. | |
| | | | | | Resistance management | |
| | | | | | required. | |
| | | aryl-phenyl- | benzophenone | metrafenone | Less sensitive isolates | 50 |
| | | ketones | benzoylpyridine | pyriofenone | detected in powdery mildews | |
| | | | | | (Blumeria and Sphaerotheca) | |
| | | | | | Medium risk. | |
| | | | | | Resistance management | |
| | | | | | required. | |
| | | | | | Reclassified from U8 in 2018 | |
| | B7 | pyridazine | pyridazine | pyridachlometyl | High risk. | 53 |
| | tubulin dynamics | | | | | |
| | modulator | | | | | |
| C. | C1 | pyrimidinamines | pyrimidinamines | diflumetorim | Resistance not known. | 39 |
| respiration | complex I NADH | pyrazole-MET1 | pyrazole-5- | tolfenpyrad | | |
| | oxido-reductase | | carboxamides | | | |
| | | Quinazoline | quinazoline | fenazaquin | | |
| | C2 | SDHI | phenyl-benzamides | benodanil | Resistance known for several | 7 |
| | complex II: | (Succinate- | | flutolanil | fungal species in field | |
| | succinate-dehydro- | dehydrogenase | | mepronil | populations and lab mutants. | |
| | genase | inhibitors) | phenyl-oxo-ethyl | isofetamid | Target site mutations in sdh | |
| | | | thiophene amide | | gene, e.g. H/Y (or H/L) at 257, | |
| | | | pyridinyl-ethyl- | fluopyram | 267, 272 or P225L, dependent | |
| | | | benzamides | | on fungal species. | |
| | | | phenyl-cyclobutyl- | cyclobutrifluram | Resistance management | |
| | | | pyridineamide | | required. | |
| | | | furan- carboxamides | fenfuram | Medium to high risk. | |
| | | | oxathiin- | carboxin | See FRAC SDHI Guidelines | |
| | | | carboxamides | oxycarboxin | for resistance management. | |
| | | | thiazole- | thifluzamide | | |
| | | | carboxamides | | | |
| | | | pyrazole-4- | benzovindiflupyr | | |
| | | | carboxamides | bixafen | | |
| | | | | fluindapyr | | |
| | | | | fluxapyroxad | | |
| | | | | furametpyr | | |
| | | | | inpyrfluxam | | |
| | | | | isopyrazam | | |
| | | | | penflufen | | |
| | | | | penthiopyrad | | |
| | | | | sedaxane | | |
| | | | N-cyclopropyl-N- | isoflucypram | | |
| | | | benzyl-pyrazole- | | | |
| | | | carboxamides | | | |
| | | | N-methoxy-(phenyl- | pydiflumetofen | | |
| | | | ethyl)-pyrazole- | | | |
| | | | carboxamides | | | |
| | | | pyridine- | boscalid | | |
| | | | carboxamides | | | |
| | | | pyrazine- | pyraziflumid | | |
| | | | carboxamides | | | |
| C. | C3 | QoI-fungicides | methoxy-acrylates | azoxystrobin | Resistance known in various | 11 |
| respiration | complex III: | (Quinone outside | | coumoxystrobin | fungal species. Target site | |
| | cytochrome bc1 | Inhibitors) | | enoxastrobin | mutations in cyt b gene (G143A, | |
| | (ubiquinol oxidase) | | | flufenoxystrobin | F129L) and additional | |
| | at Qo site (cyt b | | | picoxystrobin | mechanisms. | |
| | gene) | | | pyraoxystrobin | Cross resistance shown | |
| | | | methoxy-acetamide | mandestrobin | between all members of the | |
| | | | methoxy-carbamates | pyraclostrobin | Code 11 fungicides. | |
| | | | | pyrametostrobin | High risk. | |
| | | | | triclopyricarb | See FRAC QoI Guidelines | |
| | | | oximino-acetates | kresoxim-methyl | for resistance management. | |
| | | | | trifloxystrobin | | |
| | | | oximino-acetamides | dimoxystrobin | | |
| | | | | fenaminstrobin | | |
| | | | | metominostrobin | | |
| | | | | orysastrobin | | |
| | | | oxazolidine-diones | famoxadone | | |
| | | | dihydro-dioxazines | fluoxastrobin | | |
| | | | imidazolinones | fenamidone | | |
| | | | benzyl-carbamates | pyribencarb | | |
| | | QoI-fungicides | tetrazolinones | metyltetraprole | Resistance not known. Not | 11A |
| | | (Quinone outside | | | cross resistant with Code 11 | |
| | | Inhibitors; | | | fungicides on G143A mutants. | |
| | | Subgroup A) | | | High risk. | |
| | | | | | See FRAC QoI Guidelines | |
| | | | | | for resistance management. | |
| C: | C4 | QiI - fungicides | cyano-imidazole | cyazofamid | Resistance risk unknown but | 21 |
| respiration | complex III: | (Quinone inside | sulfamoyl-triazole | amisulbrom | assumed to be medium to high | |
| (continued) | cytochrome bc1 | Inhibitors) | picolinamides | fenpicoxamid | (mutations at target site known | |
| | (ubiquinone | | | florylpicoxamid | in model organisms). | |
| | reductase) at Qi site | | | | Resistance management | |
| | | | | | required. | |
| | | | | | No spectrum overlap with the | |
| | | | | | Oomycete-fungicides | |
| | | | | | cyazofamid and amisulbrom | |
| | C5 | | dinitrophenyl- | binapacryl | Resistance not known. | 29 |
| | uncouplers of | | crotonates | meptyldinocap | Also acaricidal activity. | |
| | oxidative phos- | | | dinocap | | |
| | phorylation | | 2,6-dinitro-anilines | fluazinam | Low risk. However, resistance | |
| | | | | | claimed in Botrytis in Japan. | |
| | | | (pyr.-hydrazones) | (ferimzone) | Reclassified to U 14 in 2012. | |
| | C6 | organo tin | tri-phenyl tin | fentin acetate | Some resistance cases | 30 |
| | inhibitors of | compounds | compounds | fentin chloride | known. Low to medium risk. | |
| | oxidative phos- | | | fentin hydroxide | | |
| | phorylation, ATP | | | | | |
| | synthase | | | | | |
| | C7 | thiophene- | thiophene- | silthiofam | Resistance reported. Risk low. | 38 |
| | ATP transport | carboxamides | carboxamides | | | |
| | (proposed) | | | | | |
| | C8 | QoSI fungicides | triazolo-pyrimidylamine | ametoctradin | Not cross resistant to QoI | 45 |
| | complex III: | (Quinone outside | | | fungicides. | |
| | cytochrome bc1 | Inhibitor, | | | Resistance risk assumed to | |
| | (ubiquinone | stigmatellin | | | be medium to high | |
| | reductase) at | binding type) | | | (single site inhibitor). | |
| | Qo site, stigmatellin | | | | Resistance management | |
| | binding sub-site | | | | required. | |
| D: | D1 | AP - fungicides | anilino-pyrimidines | cyprodinil | Resistance known in Botrytis | 9 |
| amino acids | methionine | (Anilino- | | mepanipyrim | and Venturia, sporadically in | |
| and protein | biosynthesis | Pyrimidines) | | pyrimethanil | Oculimacula. | |
| [symbol] | (proposed) | | | | Medium risk. | |
| | (cgs gene) | | | | See FRAC Anilinopyrimidine | |
| | | | | | Guidelines | |
| | | | | | for resistance management. | |
| | D2 | enopyranuronic | enopyranuronic acid | blasticidin-S | Low to medium risk. | 23 |
| | protein synthesis | acid antibiotic | antibiotic | | Resistance management | |
| | (ribosome, | | | | required. | |
| | termination step) | | | | | |
| | D3 | hexopyranosyl | hexopyranosyl | kasugamycin | Resistance known in fungal | 24 |
| | protein synthesis | antibiotic | antibiotic | | and bacterial (P. glumae) | |
| | (ribosome, initiation | | | | pathogens. Medium risk. | |
| | step) | | | | Resistance management | |
| | | | | | required. | |
| | D4 | glucopyranosyl | glucopyranosyl | streptomycin | Bactericide. Resistance | 25 |
| | protein synthesis | antibiotic | antibiotic | | known. High risk. | |
| | (ribosome, initiation | | | | Resistance management | |
| | step) | | | | required. | |
| | D5 | tetracycline | tetracycline | oxytetracycline | Bactericide. Resistance | 41 |
| | protein synthesis | antibiotic | antibiotic | | known. High risk. | |
| | (ribosome, | | | | Resistance management | |
| | elongation step) | | | | required. | |
| E: | E1 | aza- | aryloxyquinoline | quinoxyfen | Resistance to quinoxyfen | 13 |
| signal | signal transduction | naphthalenes | quinazolinone | proquinazid | known. | |
| transduction | (mechanism | | | | Medium risk. | |
| | unknown) | | | | Resistance management | |
| | | | | | required. Cross resistance | |
| | | | | | found in Erysiphe (Uncinula) | |
| | | | | | necator but not in Blumeria | |
| | | | | | graminis. | |
| | E2 | PP-fungicides | phenylpyrroles | fenpiclonil | Resistance found sporadically, | 12 |
| | MAP/Histidine- | (PhenylPyrroles) | | fludioxonil | mechanism speculative. | |
| | Kinase in osmotic | | | | Low to medium risk. | |
| | signal transduction | | | | Resistance management | |
| | (os-2, HOG1) | | | | required. | |
| | E3 | dicarboximides | dicarboximides | chlozolinate | Resistance common in Botrytis | 2 |
| | MAP/Histidine- | | | dimethachlone | and some other pathogens. | |
| | Kinase in osmotic | | | iprodione | Several mutations in OS-1, | |
| | signal transduction | | | procymidone | mostly I365S. | |
| | (os-1, Daf1) | | | vinclozolin | Cross resistance common | |
| | | | | | between the group members. | |
| | | | | | Medium to high risk. | |
| | | | | | See FRAC Dicarboximide | |
| | | | | | Guidelines | |
| | | | | | for resistance management | |

| | | |
|---|---|---|
| F: lipid | F1 | formerly dicarboximides |

| | | | | | | |
|---|---|---|---|---|---|---|
| synthesis or | F2 | phosphoro- | phosphoro- | edifenphos | Resistance known in specific | 6 |
| transport/ | phospholipid | thiolates | thiolates | iprobenfos (IBP) | fungi. | |
| membrane | biosynthesis, | | | pyrazophos | Low to medium risk. | |
| integrity or | methyltransferase | Dithiolanes | dithiolanes | isoprothiolane | Resistance management | |
| function | | | | | required if used for risky | |
| | | | | | pathogens. | |
| | F3 | AH-fungicides | aromatic hydrocarbons | biphenyl | Resistance known in some | 14 |
| | cell peroxidation | (Aromatic | | chloroneb | fungi. | |
| | (proposed) | Hydrocarbons) | | dicloran | Low to medium risk. | |
| | | (chlorophenyls, | | quintozene (PCNB) | Cross resistance patterns | |
| | | nitroanilines) | | tecnazene (TCNB) | complex due to different | |
| | | | | tolclofos-methyl | activity spectra. | |
| | | heteroaromatics | 1,2,4-thiadiazoles | etridiazole | | |
| | F4 | Carbamates | carbamates | iodocarb | Low to medium risk. | 28 |
| | cell membrane | | | propamocarb | Resistance management | |
| | permeability, fatty | | | prothiocarb | required. | |
| | acids (proposed) | | | | | |

| | |
|---|---|
| F5 | formerly CAA-fungicides |
| F6 | formerly Bacillus amyloliquefaciens |
| microbial disrupters | strains (FRAC Code 44); |
| of pathogen cell | reclassified to BM02 in 2020 |
| membranes | |
| F7 | formerly extract from Melaleuca |
| cell membrane | alternifolia (tea tree oil) and plant |
| disruption | oils (eugenol, geraniol, thymol) FRAC Code 46, |
| | reclassified to BM01 in 2021 |

| | | | | | | |
|---|---|---|---|---|---|---|
| | F8 | Polyene | amphoteric macrolide | natamycin | Resistance not known. | 48 |
| | ergosterol binding | | antifungal antibiotic | (pimaricin) | Agricultural, food and topical | |
| | | | from Streptomyces | | medical uses. | |
| | | | natalensis or | | | |
| | | | S. chattanoogensis | | | |
| | F9 | OSBPI | piperidinyl-thiazole- | oxathiapiprolin | Resistance risk assumed to be | 49 |
| | lipid homeostasis | oxysterol binding | isoxazolines | fluoxapiprolin | medium to high (single site | |
| | and transfer/storage | protein | | | inhibitor). Resistance | |
| | | homologue | | | management required. | |
| | | inhibition | | | (Previously U15). | |
| | F10 | protein fragment | polypeptide | polypeptide | Resistance not known. | 51 |
| | interaction with lipid | | | ASFBIOF01-02 | | |
| | fraction of the cell | | | | | |
| | membrane, with | | | | | |
| | multiple effects on | | | | | |
| | cell membrane | | | | | |
| | integrity | | | | | |
| G: sterol | G1 | DMI-fungicides | piperazines | triforine | There are big differences in | 3 |
| biosynthesis | C14- demethylase | (DeMethylation | pyridines | pyrifenox | the activity spectra of DMI | |
| in [symbol] | in sterol | Inhibitors) | | pyrisoxazole | fungicides. | |
| | biosynthesis | (SBI: Class I) | pyrimidines | fenarimol | Resistance is known in various | |
| | (erg11/cyp51) | | | nuarimol | fungal species. Several | |
| | | | imidazoles | imazalil | resistance mechanisms are | |
| | | | | oxpoconazole | known incl. target site | |
| | | | | pefurazoate | mutations in cyp51 (erg 11) | |
| | | | | prochloraz | gene, e.g. V136A, Y137F, | |
| | | | | triflumizole | A379G, I381V; cyp51 | |
| | | | triazoles | azaconazole | promotor; ABC transporters | |
| | | | triazolinthiones | bitertanol | and others. | |
| | | | | bromuconazole | Generally wise to accept that | |
| | | | | cyproconazole | cross resistance is present | |
| | | | | difenoconazole | between DMI fungicides active | |
| | | | | diniconazole | against the same fungus. | |
| | | | | epoxiconazole | DMI fungicides are Sterol | |
| | | | | etaconazole | Biosynthesis Inhibitors (SBIs), | |
| | | | | fenbuconazole | but show no cross resistance | |
| | | | | fluquinconazole | to other SBI classes. | |
| | | | | flusilazole | Medium risk. | |
| | | | | flutriafol | See FRAC SBI Guidelines | |
| | | | | hexaconazole | for resistance management. | |
| | | | | imibenconazole | | |
| | | | | ipconazole | | |
| | | | | mefentrifluconazole | | |
| | | | | metconazole | | |
| | | | | myclobutanil | | |
| | | | | penconazole | | |
| | | | | propiconazole | | |
| | | | | simeconazole | | |
| | | | | tebuconazole | | |
| | | | | tetraconazole | | |
| | | | | triadimefon | | |
| | | | | triadimenol | | |
| | | | | triticonazole | | |
| | | | | prothioconazole | | |
| | G2 | amines | morpholines | aldimorph | Decreased sensitivity for | 5 |
| | Δ¹⁴-reductase | (“morpholines”) | | dodemorph | powdery mildews. | |
| | and | (SBI: Class II) | | fenpropimorph | Cross resistance within the | |
| | Δ⁸→Δ⁷⁻ | | | tridemorph | group generally found but not | |
| | isomerase | | piperidines | fenpropidin | to other | |
| | in sterol | | | piperalin | SBI classes | |
| | biosynthesis | | spiroketal-amines | spiroxamine | Low to medium risk. | |
| | (erg24, erg2) | | | | See FRAC SBI Guidelines | |
| | | | | | for resistance management | |
| | G3 | KRI fungicides | hydroxyanilides | fenhexamid | Low to medium risk. | 17 |
| | 3-keto reductase, | (KetoReductase | amino-pyrazolinone | fenpyrazamine | Resistance management | |
| | C4- de-methylation | Inhibitors) | | | required. | |
| | (erg27) | (SBI: Class III) | | | | |
| | G4 | (SBI class IV) | thiocarbamates | pyributicarb | Resistance not known, | 18 |
| | squalene-epoxidase | | allylamines | naftifine | fungicidal and herbicidal | |
| | in sterol | | | terbinafine | activity. | |
| | biosynthesis | | | | Medical fungicides only. | |
| | (erg1) | | | | | |

| | | | | |
|---|---|---|---|---|
| H: cell wall | H3 | Formerly glucopyranosyl | reclassified to U18 | 26 |
| biosynthesis | | antibiotic (validamycin) | | |

| | | | | | | |
|---|---|---|---|---|---|---|
| | H4 | polyoxins | peptidyl pyrimidine | polyoxin | Resistance known. | 19 |
| | chitin synthase | | nucleoside | | Medium risk. | |
| | | | | | Resistance management | |
| | | | | | required. | |
| | H5 | CAA-fungicides | cinnamic acid amides | dimethomorph | Resistance known in | 40 |
| | cellulose synthase | (Carboxylic Acid | | flumorph | Plasmopara viticola but not in | |
| | | Amides) | | pyrimorph | Phytophthora infestans. | |
| | | | valinamide | benthiavalicarb | Cross resistance between all | |
| | | | carbamates | iprovalicarb | members of the CAA group. | |
| | | | | valifenalate | Low to medium risk. | |
| | | | mandelic acid amides | mandipropamid | See FRAC CAA Guidelines for | |
| | | | | | resistance management. | |
| I: melanin | I1 | MBI-R | isobenzo-furanone | fthalide | Resistance not known. | 16.1 |
| synthesis in | reductase in | (Melanin | pyrrolo-quinolinone | pyroquilon | | |
| cell wall | melanin | Biosynthesis | triazolobenzo- | tricyclazole | | |
| | biosynthesis | Inhibitors - | thiazole | | | |
| | | Reductase) | | | | |
| | I2 | MBI-D | cyclopropane- | carpropamid | Resistance known. | 16.2 |
| | dehydratase in | (Melanin | carboxamide | | Medium risk. | |
| | melanin | Biosynthesis | carboxamide | diclocymet | Resistance management | |
| | biosynthesis | Inhibitors - | propionamide | fenoxanil | required. | |
| | | Dehydratase) | | | | |
| | I3 | MBI-P | trifluoroethyl- | tolprocarb | Resistance not known. | 16.3 |
| | polyketide synthase | (Melanin | carbamate | | Additional activity against | |
| | in melanin | Biosynthesis | | | bacteria and fungi through | |
| | biosynthesis | Inhibitors - | | | induction of host plant defence | |
| | | Polyketide | | | | |
| | | synthase) | | | | |
| P: host plant | P 01 | benzo- | benzo- | acibenzolar-S-methyl | Resistance not known. | P 01 |
| defence | salicylate-related | thiadiazole | thiadiazole | | | |
| induction | | (BTH) | (BTH) | | | |
| | P 02 | benzisothiazole | benzisothiazole | probenazole | Resistance not known. | P 02 |
| | salicylate-related | | | (also antibacterial and | | |
| | | | | antifungal activity) | | |
| | P 03 | thiadiazole- | thiadiazole- | tiadinil | Resistance not known. | P 03 |
| | salicylate-related | carboxamide | carboxamide | isotianil | | |
| | P 04 | natural | polysaccharides | laminarin | Resistance not known. | P 04 |
| | polysaccharide | compound | | | | |
| | elicitors | | | | | |
| | P 05 | plant extract | complex mixture, | extract from Reynoutria | Resistance not known. | P 05 |
| | anthraquinone | | ethanol extract | sachalinensis (giant | | |
| | elicitors | | (anthraquinones, | knotweed) | | |
| | | | resveratrol) | | | |
| | P 06 | microbial | bacterial | Bacillus mycoides | Resistance not known. | P 06 |
| | microbial elicitors | | Bacillus spp. | isolate J | | |
| | | | fungal | cell walls of Saccharomyces | | |
| | | | Saccharomyces | cerevisiae | | |
| | | | spp. | strain LAS117 | | |
| | P 07 | phosphonates | ethyl phosphonates | fosetyl-Al | Few resistance cases | P07 |
| | phosphonates | | | phosphorous acid and | reported in few | |
| | | | | salts | pathogens. | |
| | | | | | Low risk. | |
| | | | | | Reclassified from U33 in | |
| | | | | | 2018 | |
| | P 08 | isothiazole | isothiazolylmethyl | dichlobentiazox | activates SAR both up- | P 08 |
| | salicylate-related | | ether | | and downstream of SA. | |
| | | | | | Resistance not known. | |
| U: | unknown | cyanoacetamide- | cyanoacetamide- | cymoxanil | Resistance claims described. | 27 |
| Unknown | | oxime | oxime | | Low to medium risk. | |
| mode of | | | | | Resistance management | |
| action | | | | | required. | |

| | |
|---|---|
| (U numbers | formerly phosphonates (FRAC code 33), |
| not | reclassified to P 07 in 2018 |

| | | | | | | |
|---|---|---|---|---|---|---|
| appearing | unknown | phthalamic acids | phthalamic acids | tecloftalam | Resistance not known. | 34 |
| in the list | | | | (Bactericide) | | |
| derive from | unknown | benzotriazines | benzotriazines | triazoxide | Resistance not known. | 35 |
| reclassified | unknown | benzene- | benzene- | flusulfamide | Resistance not known. | 36 |
| fungicides) | unknown | pyridazinones | pyridazinones | diclomezine | Resistance not known. | 37 |

formerly methasulfocarb (FRAC code 42),
reclassified to M 12 in 2018

| | | | | | | |
|---|---|---|---|---|---|---|
| | unknown | phenyl- | phenyl- | cyflufenamid | Resistance in Sphaerotheca. | U 06 |
| | | acetamide | acetamide | | Resistance management | |
| | | | | | required | |
| | cell membrane | guanidines | guanidines | dodine | Resistance known in | U 12 |
| | disruption | | | | Venturia inaequalis. | |
| | (proposed) | | | | Low to medium risk. | |
| | | | | | Resistance management | |
| | | | | | recommended. | |
| | unknown | thiazolidine | cyano-methylene- | flutianil | Resistance in Sphaerotheca and | U 13 |
| | | | thiazolidines | | Podosphaera xanthii. | |
| | | | | | Resistance management | |
| | | | | | required. | |
| | unknown | pyrimidinone- | pyrimidinone- | ferimzone | Resistance not known | U 14 |
| | | hydrazones | hydrazones | | (previously C5). | |
| | complex III: | 4-quinolyl- | 4-quinolyl- | tebufloquin | Not cross resistant to QoI. | U 16 |
| | cytochrome bc1, | acetate | acetates | | Resistance risk unknown but | |
| | unknown binding | | | | assumed to be medium. | |
| | site (proposed) | | | | Resistance management | |
| | | | | | required. | |
| | Unknown | tetrazolyloxime | tetrazolyloximes | picarbutrazox | Resistance not known. | U 17 |
| | | | | | Not cross resistant to | |
| | | | | | PA, QoI, CAA. | |
| | Unknown | glucopyranosyl | glucopyranosyl | validamycin | Resistance not known. | U 18 |
| | (Inhibition of | antibiotic | antibiotics | | Induction of host plant defense | |
| | trehalase) | | | | by trehalose proposed | |
| | | | | | (previously H3). | |
| Not | Unknown | diverse | diverse | mineral oils, | Resistance not known. | NC |
| specified | | | | organic oils, | | |
| | | | | inorganic salts, | | |
| | | | | material of | | |
| | | | | biological origin | | |
| M: | multi-site | inorganic | inorganic | copper | Also applies to organic copper | M 01 |
| Chemicals | contact | (electrophiles) | | (different salts) | complexes | |
| with multi-site | activity | inorganic | inorganic | sulphur | generally considered as a low | M 02 |
| activity | | (electrophiles) | | | risk group without any signs of | |
| | | dithiocarbamates | dithio-carbamates | amobam | resistance developing to the | M 03 |
| | | and relatives | and relatives | ferbam | fungicides. | |
| | | (electrophiles) | | mancozeb | reclassified from U42 in 2018 | |
| | | | | maneb | | |
| | | | | metiram | | |
| | | | | propineb | | |
| | | | | thiram | | |
| | | | | zinc thiazole | | |
| | | | | zineb | | |
| | | | | ziram | | |
| | | phthalimides | phthalimides | captan | | M 04 |
| | | (electrophiles) | | captafol | | |
| | | | | folpet | | |
| | | chloronitriles | chloronitriles | chlorothalonil | | M 05 |
| | | (phthalonitriles) | (phthalonitriles) | | | |
| | | (unspecified | | | | |
| | | mechanism) | | | | |
| | | sulfamides | sulfamides | dichlofluanid | | M 06 |
| | | (electrophiles) | | tolylfluanid | | |
| | | bis-guanidines | bis-guanidines | guazatine | | M 07 |
| | | (membrane | | iminoctadine | | |
| | | disruptors, | | | | |
| | | detergents) | | | | |
| | | triazines | triazines | anilazine | | M 08 |
| | | (unspecified | | | | |
| | | mechanism) | | | | |
| | | quinones | quinones | dithianon | | M 09 |
| | | (anthraquinones) | (anthraquinones) | | | |
| | | (electrophiles) | | | | |
| | | quinoxalines | quinoxalines | chinomethionat/ | | M 10 |
| | | (electrophiles) | | quinomethionate | | |
| | | maleimide | maleimide | fluoroimide | | M 11 |
| | | (electrophiles) | | | | |
| | | thiocarbamate | thiocarbamate | methasulfocarb | | M 12 |
| | | (electrophiles) | | | | |

| | | | CHEMICAL OR | | | |
|---|---|---|---|---|---|---|
| | TARGET | GROUP | BIOLOGICAL | COMMON | | FRAC |
| MOA | SITE | NAME | GROUP | NAME | COMMENTS | CODE |
| BM: | multiple effects | plant extract | polypeptide (lectin) | extract from the | Resistance not known. | BM 01 |
| Biologicals | on ion membrane | | | cotyledons of | (previously M12). | |
| with | transporters; | | | lupine plantlets | | |
| multiple | chelating effects | | | (“BLAD”) | | |
| modes | affects fungal | plant extract | phenols, | extract from | Resistance not known. | |
| of | spores and germ | | sesquiterpenes, | Swinglea glutinosa | | |
| action: | tubes, | | triterpenoids, | | | |
| Plant | induced plant | | coumarins | | | |
| extracts | defense | | | | | |
| | cell membrane | plant extract | terpene | extract from | Resistance not known. | |
| | disruption, cell wall, | | hydrocarbons, | Melaleuca | (previously F7) | |
| | induced plant | | terpene alcohols and | alternifolia | | |
| | defense | | terpene phenols | (tea tree oil) | | |
| | mechanisms | | | plant oils | | |
| | | | | (mixtures): | | |
| | | | | eugenol, geraniol, | | |
| | | | | thymol | | |
| BM: | multiple effects | microbial | fungal | T. atroviride | nomenclature change from | BM 02 |
| Biologicals | described | (strains | Trichoderma spp. | strain I-1237 | Gliocladium catenulatum to | |
| with | (examples, not all | of living | | strain LU132 | Clonostachys rosea | |
| multiple | apply to all | microbes or | | strain SC1 | Resistance not known. | |
| modes | biological groups): | extract, | | strain SKT-1 | Bacillus amyloliquefaciens | |
| of | competition, | metabolites) | | strain 77B | reclassified from F6, | |
| action: | mycoparasitism, | | | T. asperellum | Code 44 in 2020 | |
| Microbial | antibiosis, | | | strain T34 | synonyms for Bacillus | |
| (living | membrane | | | strain kd | amyloliquefaciens are Bacillus | |
| microbes, | disruption by | | | T. harzianum | subtilis and B. subtilis var. | |
| extracts | fungicidal | | | strain T-22 | amyloliquefaciens (previous | |
| or | lipopeptides, | | | T. virens | taxonomic classification). | |
| metabolites) | lytic enzymes, | | | strain G-41 | | |
| | induced plant | | fungal | C. rosea | | |
| | defence | | Clonostachys spp. | strain J1446 | | |
| | | | | strain CR-7 | | |
| | | | fungal | C. minitans | | |
| | | | Coniothyrium spp. | strain CON/M/91-08 | | |
| | | | fungal | H. uvarum | | |
| | | | Hanseniaspora spp. | strain BC18Y | | |
| | | | fungal | T. flavus | | |
| | | | Talaromyces spp. | strain SAY-Y-94-01 | | |
| | | | fungal | S. cerevisae | | |
| | | | Saccharomyces spp. | strain LAS02 | | |
| | | | | strain DDSF623 | | |
| | | | bacterial | B. amyloliquefaciens | | |
| | | | Bacillus spp. | strain QST713 | | |
| | | | | strain FZB24 | | |
| | | | | strain MBI600 | | |
| | | | | strain D747 | | |
| | | | | strain F727 | | |
| | | | | strain AT-332 | | |
| | | | | B. subtilis | | |
| | | | | strain AFS032321 | | |
| | | | | strain Y1336 | | |
| | | | | strain HAI-0404 | | |
| | | | bacterial | PHC25279 | | |
| | | | Erwinia spp. | | | |
| | | | (peptide) | | | |
| | | | bacterial | G. cerinus | | |
| | | | Gluconobacter spp. | strain BC18B | | |
| | | | bacterial | P. chlororaphis | | |
| | | | Pseudomonas spp. | strain AFS009 | | |
| | | | bacterial | S. griseovirides | | |
| | | | Streptomyces spp. | strain K61 | | |
| | | | | S. lydicus | | |
| | | | | strain WYEC108 | | |

[symbol]

indicates data missing or illegible when filed

APPENDIX 2

| MODE OF ACTION | CHEMICAL CLASSIFICATION | ACTIVE |
|---|---|---|
| Inhibition of Acetyl CoA | Cyclohexanediones (DIMs) | Alloxydim |
| Carboxylase | | |
| Inhibition of Acetyl CoA | Cyclohexanediones (DIMs) | Butroxydim |
| Carboxylase | | |
| Inhibition of Acetyl CoA | Cyclohexanediones (DIMs) | Clethodim |
| Carboxylase | | |
| Inhibition of Acetyl CoA | Cyclohexanediones (DIMs) | Cloproxydim |
| Carboxylase | | |
| Inhibition of Acetyl CoA | Cyclohexanediones (DIMs) | Cycloxydim |
| Carboxylase | | |
| Inhibition of Acetyl CoA | Cyclohexanediones (DIMs) | Profoxydim |
| Carboxylase | | |
| Inhibition of Acetyl CoA | Cyclohexanediones (DIMs) | Sethoxydim |
| Carboxylase | | |
| Inhibition of Acetyl CoA | Cyclohexanediones (DIMs) | Tepraloxydim |
| Carboxylase | | |
| Inhibition of Acetyl CoA | Cyclohexanediones (DIMs) | Tralkoxydim |
| Carboxylase | | |
| Inhibition of Acetyl CoA | Aryloxyphenoxy-propionates | Clodinafop-propargyl |
| Carboxylase | (FOPs) | |
| Inhibition of Acetyl CoA | Aryloxyphenoxy-propionates | Clofop |
| Carboxylase | (FOPs) | |
| Inhibition of Acetyl CoA | Aryloxyphenoxy-propionates | Cyhalofop-butyl |
| Carboxylase | (FOPs) | |
| Inhibition of Acetyl CoA | Aryloxyphenoxy-propionates | Diclofop-methyl |
| Carboxylase | (FOPs) | |
| Inhibition of Acetyl CoA | Aryloxyphenoxy-propionates | Fenoxaprop-ethyl |
| Carboxylase | (FOPs) | |
| Inhibition of Acetyl CoA | Aryloxyphenoxy-propionates | Fenthiaprop |
| Carboxylase | (FOPs) | |
| Inhibition of Acetyl CoA | Aryloxyphenoxy-propionates | Fluazifop-butyl |
| Carboxylase | (FOPs) | |
| Inhibition of Acetyl CoA | Aryloxyphenoxy-propionates | Haloxyfop-methyl |
| Carboxylase | (FOPs) | |
| Inhibition of Acetyl CoA | Aryloxyphenoxy-propionates | Isoxapyrifop |
| Carboxylase | (FOPs) | |
| Inhibition of Acetyl CoA | Aryloxyphenoxy-propionates | Metamifop |
| Carboxylase | (FOPs) | |
| Inhibition of Acetyl CoA | Aryloxyphenoxy-propionates | Quizalofop-ethyl |
| Carboxylase | (FOPs) | |
| Inhibition of Acetyl COA | Phenylpyrazoline | Pinoxaden |
| Carboxylase | | |
| Inhibition of Acetolactate | Pyrimidinyl benzoates | Bispyribac-sodium |
| Synthase | | |
| Inhibition of Acetolactate | Pyrimidinyl benzoates | Pyribenzoxim (prodrug of |
| Synthase | | bispyribac) |
| Inhibition of Acetolactate | Pyrimidinyl benzoates | Pyriftalid |
| Synthase | | |
| Inhibition of Acetolactate | Pyrimidinyl benzoates | Pyriminobac-methyl |
| Synthase | | |
| Inhibition of Acetolactate | Pyrimidinyl benzoates | Pyrithiobac-sodium |
| Synthase | | |
| Inhibition of Acetolactate | Sulfonanilides | Pyrimisulfan |
| Synthase | | |
| Inhibition of Acetolactate | Sulfonanilides | Triafamone |
| Synthase | | |
| Inhibition of Acetolactate | Triazolopyrimidine-Type 1 | Cloransulam-methyl |
| Synthase | | |
| Inhibition of Acetolactate | Triazolopyrimidine-Type 1 | Diclosulam |
| Synthase | | |
| Inhibition of Acetolactate | Triazolopyrimidine-Type 1 | Florasulam |
| Synthase | | |
| Inhibition of Acetolactate | Triazolopyrimidine-Type 1 | Flumetsulam |
| Synthase | | |
| Inhibition of Acetolactate | Triazolopyrimidine-Type 1 | Metosulam |
| Synthase | | |
| Inhibition of Acetolactate | Triazolopyrimidine-Type 2 | Penoxsulam |
| Synthase | | |
| Inhibition of Acetolactate | Triazolopyrimidine-Type 2 | Pyroxsulam |
| Synthase | | |
| Inhibition of Acetolactate | Sulfonylureas | Amidosulfuron |
| Synthase | | |
| Inhibition of Acetolactate | Sulfonylureas | Azimsulfuron |
| Synthase | | |
| Inhibition of Acetolactate | Sulfonylureas | Bensulfuron-methyl |
| Synthase | | |
| Inhibition of Acetolactate | Sulfonylureas | Chlorimuron-ethyl |
| Synthase | | |
| Inhibition of Acetolactate | Sulfonylureas | Chlorsulfuron |
| Synthase | | |
| Inhibition of Acetolactate | Sulfonylureas | Cinosulfuron |
| Synthase | | |
| Inhibition of Acetolactate | Sulfonylureas | Cyclosulfamuron |
| Synthase | | |
| Inhibition of Acetolactate | Sulfonylureas | Ethametsulfuron-methyl |
| Synthase | | |
| Inhibition of Acetolactate | Sulfonylureas | Ethoxysulfuron |
| Synthase | | |
| Inhibition of Acetolactate | Sulfonylureas | Flazasulfuron |
| Synthase | | |
| Inhibition of Acetolactate | Sulfonylureas | Flucetosulfuron |
| Synthase | | |
| Inhibition of Acetolactate | Sulfonylureas | Flupyrsulfuron-methyl-Na |
| Synthase | | |
| Inhibition of Acetolactate | Sulfonylureas | Foramsulfuron |
| Synthase | | |
| Inhibition of Acetolactate | Sulfonylureas | Halosulfuron-methyl |
| Synthase | | |
| Inhibition of Acetolactate | Sulfonylureas | Imazosulfuron |
| Synthase | | |
| Inhibition of Acetolactate | Sulfonylureas | lodosulfuron-methyl-Na |
| Synthase | | |
| Inhibition of Acetolactate | Sulfonylureas | Mesosulfuron-methyl |
| Synthase | | |
| Inhibition of Acetolactate | Sulfonylureas | Metazosulfuron |
| Synthase | | |
| Inhibition of Acetolactate | Sulfonylureas | Metsulfuron-methyl |
| Synthase | | |
| Inhibition of Acetolactate | Sulfonylureas | Nicosulfuron |
| Synthase | | |
| Inhibition of Acetolactate | Sulfonylureas | Orthosulfamuron |
| Synthase | | |
| Inhibition of Acetolactate | Sulfonylureas | Oxasulfuron |
| Synthase | | |
| Inhibition of Acetolactate | Sulfonylureas | Primisulfuron-methyl |
| Synthase | | |
| Inhibition of Acetolactate | Sulfonylureas | Propyrisulfuron |
| Synthase | | |
| Inhibition of Acetolactate | Sulfonylureas | Prosulfuron |
| Synthase | | |
| Inhibition of Acetolactate | Sulfonylureas | Pyrazosulfuron-ethyl |
| Synthase | | |
| Inhibition of Acetolactate | Sulfonylureas | Rimsulfuron |
| Synthase | | |
| Inhibition of Acetolactate | Sulfonylureas | Sulfometuron-methyl |
| Synthase | | |
| Inhibition of Acetolactate | Sulfonylureas | Sulfosulfuron |
| Synthase | | |
| Inhibition of Acetolactate | Sulfonylureas | Triasulfuron |
| Synthase | | |
| Inhibition of Acetolactate | Sulfonylureas | Tribenuron-methyl |
| Synthase | | |
| Inhibition of Acetolactate | Sulfonylureas | Thifensulfuron-methyl |
| Synthase | | |
| Inhibition of Acetolactate | Sulfonylureas | Trifloxysulfuron-Na |
| Synthase | | |
| Inhibition of Acetolactate | Sulfonylureas | Triflusulfuron-methyl |
| Synthase | | |
| Inhibition of Acetolactate | Sulfonylureas | Tritosulfuron |
| Synthase | | |
| Inhibition of Acetolactate | Imidazolinones | Imazamethabenz-methyl |
| Synthase | | |
| Inhibition of Acetolactate | Imidazolinones | Imazamox |
| Synthase | | |
| Inhibition of Acetolactate | Imidazolinones | Imazapic |
| Synthase | | |
| Inhibition of Acetolactate | Imidazolinones | Imazapyr |
| Synthase | | |
| Inhibition of Acetolactate | Imidazolinones | Imazaquin |
| Synthase | | |
| Inhibition of Acetolactate | Imidazolinones | Imazethapyr |
| Synthase | | |
| Inhibition of Acetolactate | Triazolinones | Flucarbazone-Na |
| Synthase | | |
| Inhibition of Acetolactate | Triazolinones | Propoxycarbazone-Na |
| Synthase | | |
| Inhibition of Acetolactate | Triazolinones | Thiencarbazone-methyl |
| Synthase | | |
| Inhbition of Photosynthesis at | Triazines | Atraton |
| PSII-Serine 264 Binders | | |
| Inhbition of Photosynthesis at | Triazines | Atrazine |
| PSII-Serine 264 Binders | | |
| Inhbition of Photosynthesis at | Triazines | Ametryne |
| PSII-Serine 264 Binders | | |
| Inhbition of Photosynthesis at | Triazines | Aziprotryne═aziprotryn |
| PSII-Serine 264 Binders | | |
| Inhbition of Photosynthesis at | Triazines | Chlorazine |
| PSII-Serine 264 Binders | | |
| Inhbition of Photosynthesis at | Triazines | CP 17029 |
| PSII-Serine 264 Binders | | |
| Inhbition of Photosynthesis at | Triazines | Cyanazine |
| PSII-Serine 264 Binders | | |
| Inhbition of Photosynthesis at | Triazines | Cyprazine |
| PSII-Serine 264 Binders | | |
| Inhbition of Photosynthesis at | Triazines | Desmetryne |
| PSII-Serine 264 Binders | | |
| Inhbition of Photosynthesis at | Triazines | Dimethametryn |
| PSII-Serine 264 Binders | | |
| Inhbition of Photosynthesis at | Triazines | Dipropetryn |
| PSII-Serine 264 Binders | | |
| Inhbition of Photosynthesis at | Triazines | Eglinazine-ethyl |
| PSII-Serine 264 Binders | | |
| Inhbition of Photosynthesis at | Triazines | Ipazine |
| PSII-Serine 264 Binders | | |
| Inhbition of Photosynthesis at | Triazines | Methoprotryne═methoprotryn |
| PSII-Serine 264 Binders | | |
| Inhbition of Photosynthesis at | Triazines | procyazine |
| PSII-Serine 264 Binders | | |
| Inhbition of Photosynthesis at | Triazines | Proglinazine-ethyl |
| PSII-Serine 264 Binders | | |
| Inhbition of Photosynthesis at | Triazines | Prometon |
| PSII-Serine 264 Binders | | |
| Inhbition of Photosynthesis at | Triazines | Prometryne |
| PSII-Serine 264 Binders | | |
| Inhbition of Photosynthesis at | Triazines | Propazine |
| PSII-Serine 264 Binders | | |
| Inhbition of Photosynthesis at | Triazines | Sebuthylazine |
| PSII-Serine 264 Binders | | |
| Inhbition of Photosynthesis at | Triazines | Secbumeton |
| PSII-Serine 264 Binders | | |
| Inhbition of Photosynthesis at | Triazines | Simetryne |
| PSII-Serine 264 Binders | | |
| Inhbition of Photosynthesis at | Triazines | Simazine |
| PSII-Serine 264 Binders | | |
| Inhbition of Photosynthesis at | Triazines | Terbumeton |
| PSII-Serine 264 Binders | | |
| Inhbition of Photosynthesis at | Triazines | Terbuthylazine |
| PSII-Serine 264 Binders | | |
| Inhbition of Photosynthesis at | Triazines | Terbutryne |
| PSII-Serine 264 Binders | | |
| Inhbition of Photosynthesis at | Triazines | Trietazine |
| PSII-Serine 264 Binders | | |
| Inhbition of Photosynthesis at | Triazolinone | Amicarbazone |
| PSII-Serine 264 Binders | | |
| Inhbition of Photosynthesis at | Triazinones | Ethiozin |
| PSII-Serine 264 Binders | | |
| Inhbition of Photosynthesis at | Triazinones | Hexazinone |
| PSII-Serine 264 Binders | | |
| Inhbition of Photosynthesis at | Triazinones | Isomethiozin |
| PSII-Serine 264 Binders | | |
| Inhbition of Photosynthesis at | Triazinones | Metamitron |
| PSII-Serine 264 Binders | | |
| Inhbition of Photosynthesis at | Triazinones | Metribuzin |
| PSII-Serine 264 Binders | | |
| Inhbition of Photosynthesis at | Uracils | Bromacil |
| PSII-Serine 264 Binders | | |
| Inhbition of Photosynthesis at | Uracils | Isocil |
| PSII-Serine 264 Binders | | |
| Inhbition of Photosynthesis at | Uracils | Lenacil |
| PSII-Serine 264 Binders | | |
| Inhbition of Photosynthesis at | Uracils | Terbacil |
| PSII-Serine 264 Binders | | |
| Inhbition of Photosynthesis at | Phenlcarbamates | Chlorprocarb |
| PSII-Serine 264 Binders | | |
| Inhbition of Photosynthesis at | Phenlcarbamates | Desmedipham |
| PSII-Serine 264 Binders | | |
| Inhbition of Photosynthesis at | Phenlcarbamates | Phenisopham |
| PSII-Serine 264 Binders | | |
| Inhbition of Photosynthesis at | Phenlcarbamates | Phenmedipham |
| PSII-Serine 264 Binders | | |
| Inhbition of Photosynthesis at | Pyridazinone | Chloridazon (═pyrazon) |
| PSII-Serine 264 Binders | | |
| Inhbition of Photosynthesis at | Pyridazinone | Brompyrazon |
| PSII-Serine 264 Binders | | |
| Inhbition of Photosynthesis at | Ureas | Benzthiazuron |
| PSII-Serine 264 Binders | | |
| Inhbition of Photosynthesis at | Ureas | Bromuron |
| PSII-Serine 264 Binders | | |
| Inhbition of Photosynthesis at | Ureas | Buturon |
| PSII-Serine 264 Binders | | |
| Inhbition of Photosynthesis at | Ureas | Chlorbromuron |
| PSII-Serine 264 Binders | | |
| Inhbition of Photosynthesis at | Ureas | Chlorotoluron |
| PSII-Serine 264 Binders | | |
| Inhbition of Photosynthesis at | Ureas | Chloroxuron |
| PSII-Serine 264 Binders | | |
| Inhbition of Photosynthesis at | Ureas | Difenoxuron |
| PSII-Serine 264 Binders | | |
| Inhbition of Photosynthesis at | Ureas | Dimefuron |
| PSII-Serine 264 Binders | | |
| Inhbition of Photosynthesis at | Ureas | Diuron |
| PSII-Serine 264 Binders | | |
| Inhbition of Photosynthesis at | Ureas | Ethidimuron |
| PSII-Serine 264 Binders | | |
| Inhbition of Photosynthesis at | Ureas | Fenuron |
| PSII-Serine 264 Binders | | |
| Inhbition of Photosynthesis at | Ureas | Fluometuron |
| PSII-Serine 264 Binders | | |
| Inhbition of Photosynthesis at | Ureas | Fluothiuron |
| PSII-Serine 264 Binders | | |
| Inhbition of Photosynthesis at | Ureas | Isoproturon |
| PSII-Serine 264 Binders | | |
| Inhbition of Photosynthesis at | Ureas | Isouron |
| PSII-Serine 264 Binders | | |
| Inhbition of Photosynthesis at | Ureas | Linuron |
| PSII-Serine 264 Binders | | |
| Inhbition of Photosynthesis at | Ureas | Metobenzuron |
| PSII-Serine 264 Binders | | |
| Inhbition of Photosynthesis at | Ureas | Metobromuron |
| PSII-Serine 264 Binders | | |
| Inhbition of Photosynthesis at | Ureas | Methabenzthiazuron |
| PSII-Serine 264 Binders | | |
| Inhbition of Photosynthesis at | Ureas | Metoxuron |
| PSII-Serine 264 Binders | | |
| Inhbition of Photosynthesis at | Ureas | Monolinuron |
| PSII-Serine 264 Binders | | |
| Inhbition of Photosynthesis at | Ureas | Monuron |
| PSII-Serine 264 Binders | | |
| Inhbition of Photosynthesis at | Ureas | Neburon |
| PSII-Serine 264 Binders | | |
| Inhbition of Photosynthesis at | Ureas | Parafluron |
| PSII-Serine 264 Binders | | |
| Inhbition of Photosynthesis at | Ureas | Siduron |
| PSII-Serine 264 Binders | | |
| Inhbition of Photosynthesis at | Ureas | Tebuthiuron |
| PSII-Serine 264 Binders | | |
| Inhbition of Photosynthesis at | Ureas | Thiazafluron |
| PSII-Serine 264 Binders | | |
| Inhbition of Photosynthesis at | Amides | Chloranocryl═dicryl |
| PSII-Serine 264 Binders | | |
| Inhbition of Photosynthesis at | Amides | Pentanochlor |
| PSII-Serine 264 Binders | | |
| Inhbition of Photosynthesis at | Amides | Propanil |
| PSII-Serine 264 Binders | | |
| Inhbition of Photosynthesis at | Nitriles | Bromofenoxim |
| PSII-Histidine 215 Binders | | |
| Inhbition of Photosynthesis at | Nitriles | Bromoxynil |
| PSII-Histidine 215 Binders | | |
| Inhbition of Photosynthesis at | Nitriles | loxynil |
| PSII-Histidine 215 Binders | | |
| Inhbition of Photosynthesis at | Phenyl-pyridazines | Pyridate |
| PSII-Histidine 215 Binders | | |
| Inhbition of Photosynthesis at | Benzothiadiazinone | Bentazon |
| PSII-Histidine 215 Binders | | |
| PS I Electron Diversion | Pyridiniums | Cyperquat |
| PS I Electron Diversion | Pyridiniums | Diquat |
| PS I Electron Diversion | Pyridiniums | Morfamquat |
| PS I Electron Diversion | Pyridiniums | Paraquat |
| Inhibition of | Diphenyl ethers | Lactofen |
| Protoporphyrinogen Oxidase | | |
| Inhibition of | Diphenyl ethers | Acifluorfen |
| Protoporphyrinogen Oxidase | | |
| Inhibition of | Diphenyl ethers | Bifenox |
| Protoporphyrinogen Oxidase | | |
| Inhibition of | Diphenyl ethers | Chlornitrofen |
| Protoporphyrinogen Oxidase | | |
| Inhibition of | Diphenyl ethers | Fomesafen |
| Protoporphyrinogen Oxidase | | |
| Inhibition of | Diphenyl ethers | Fluorodifen |
| Protoporphyrinogen Oxidase | | |
| Inhibition of | Diphenyl ethers | Fluoroglycofen-ethyl |
| Protoporphyrinogen Oxidase | | |
| Inhibition of | Diphenyl ethers | Fluoronitrofen |
| Protoporphyrinogen Oxidase | | |
| Inhibition of | Diphenyl ethers | Nitrofen |
| Protoporphyrinogen Oxidase | | |
| Inhibition of | Diphenyl ethers | Oxyfluorfen |
| Protoporphyrinogen Oxidase | | |
| Inhibition of | Diphenyl ethers | Chlomethoxyfen |
| Protoporphyrinogen Oxidase | | |
| Inhibition of | Phenylpyrazoles | Pyraflufen-ethyl |
| Protoporphyrinogen Oxidase | | |
| Inhibition of | N-Phenyl-oxadiazolones | Oxadiargyl |
| Protoporphyrinogen Oxidase | | |
| Inhibition of | N-Phenyl-oxadiazolones | Oxadiazon |
| Protoporphyrinogen Oxidase | | |
| Inhibition of | N-Phenyl-triazolinones | Azafenidin |
| Protoporphyrinogen Oxidase | | |
| Inhibition of | N-Phenyl-triazolinones | Carfentrazone-ethyl |
| Protoporphyrinogen Oxidase | | |
| Inhibition of | N-Phenyl-triazolinones | Sulfentrazone |
| Protoporphyrinogen Oxidase | | |
| Inhibition of | N-Phenyl-imides (procide acitive | Fluthiacet-methyl |
| Protoporphyrinogen Oxidase | form) | |
| Inhibition of | N-Phenyl-imides | Butafenacil |
| Protoporphyrinogen Oxidase | | |
| Inhibition of | N-Phenyl-imides | Saflufenacil |
| Protoporphyrinogen Oxidase | | |
| Inhibition of | N-Phenyl-imides | Pentoxazone |
| Protoporphyrinogen Oxidase | | |
| Inhibition of | N-Phenyl-imides | Chlorphthalim |
| Protoporphyrinogen Oxidase | | |
| Inhibition of | N-Phenyl-imides | Cinidon-ethyl |
| Protoporphyrinogen Oxidase | | |
| Inhibition of | N-Phenyl-imides | Flumiclorac-pentyl |
| Protoporphyrinogen Oxidase | | |
| Inhibition of | N-Phenyl-imides | Flumioxazin |
| Protoporphyrinogen Oxidase | | |
| Inhibition of | N-Phenyl-imides | Flumipropyn |
| Protoporphyrinogen Oxidase | | |
| Inhibition of | N-Phenyl-imides | Trifludimoxazin |
| Protoporphyrinogen Oxidase | | |
| Inhibition of | N-Phenyl-imides | Tiafenacil |
| Protoporphyrinogen Oxidase | | |
| Inhibition of | Other | Pyraclonil |
| Protoporphyrinogen Oxidase | | |
| Inhibition of Phytoene | Phenyl ethers | Beflubutamid |
| Desaturase | | |
| Inhibition of Phytoene | Phenyl ethers | Diflufenican |
| Desaturase | | |
| Inhibition of Phytoene | Phenyl ethers | Picolinafen |
| Desaturase | | |
| Inhibition of Phytoene | N-Phenyl heterocycles | Flurochloridone |
| Desaturase | | |
| Inhibition of Phytoene | N-Phenyl heterocycles | Norflurazon |
| Desaturase | | |
| Inhibition of Phytoene | Diphenyl heterocycles | Fluridone |
| Desaturase | | |
| Inhibition of Phytoene | Diphenyl heterocycles | Flurtamone |
| Desaturase | | |
| Inhibition of Hydroxyphenyl | Triketones | Mesotrione |
| Pyruvate Dioxygenase | | |
| Inhibition of Hydroxyphenyl | Triketones | Sulcotrione |
| Pyruvate Dioxygenase | | |
| Inhibition of Hydroxyphenyl | Triketones | Tembotrione |
| Pyruvate Dioxygenase | | |
| Inhibition of Hydroxyphenyl | Triketones | Tefuryltrione |
| Pyruvate Dioxygenase | | |
| Inhibition of Hydroxyphenyl | Triketones | Bicyclopyrone |
| Pyruvate Dioxygenase | | |
| Inhibition of Hydroxyphenyl | Triketones | Fenquinotrione |
| Pyruvate Dioxygenase | | |
| Inhibition of Hydroxyphenyl | Triketones (procide) | Benzobicyclon |
| Pyruvate Dioxygenase | | |
| Inhibition of Hydroxyphenyl | Pyrazoles (procide) | Benzofenap |
| Pyruvate Dioxygenase | | |
| Inhibition of Hydroxyphenyl | Pyrazoles | Pyrasulfotole |
| Pyruvate Dioxygenase | | |
| Inhibition of Hydroxyphenyl | Pyrazoles | Topramezone |
| Pyruvate Dioxygenase | | |
| Inhibition of Hydroxyphenyl | Pyrazoles (procide) | Pyrazolynate |
| Pyruvate Dioxygenase | | |
| Inhibition of Hydroxyphenyl | Pyrazoles (procide) | Pyrazoxyfen |
| Pyruvate Dioxygenase | | |
| Inhibition of Hydroxyphenyl | Pyrazoles | Tolpyralate |
| Pyruvate Dioxygenase | | |
| Inhibition of Hydroxyphenyl | Isoxazoles | Isoxaflutole |
| Pyruvate Dioxygenase | | |
| Inhibition of Homogentisate | Phenoxypyridazine | Cyclopyrimorate |
| Solanesyltransferase | | |
| Inhibition of Deoxy-D-Xyulose | Isoxazolidinone | Clomazone |
| Phosphate Synthase | | |
| Inhibition of Deoxy-D-Xyulose | Isoxazolidinone | Bixlozone |
| Phosphate Synthase | | |
| Inhibition of Enolpyruvyl | Glycine | Glyphosate |
| Shikimate Phosphate | | |
| Synthase | | |
| Inhibition of Glutamine | Phosphinic acids | Glufosinate-ammonium |
| Synthetase | | |
| Inhibition of Glutamine | Phosphinic acids | Bialaphos/bilanafos |
| Synthetase | | |
| Inhibition of Dihydropteroate | Carbamate | Asulam |
| Synthase | | |
| Inhibition of Microtubule | Dinitroanilines | Benefin═benfluralin |
| Assembly | | |
| Inhibition of Microtubule | Dinitroanilines | Butralin |
| Assembly | | |
| Inhibition of Microtubule | Dinitroanilines | Dinitramine |
| Assembly | | |
| Inhibition of Microtubule | Dinitroanilines | Ethalfluralin |
| Assembly | | |
| Inhibition of Microtubule | Dinitroanilines | Fluchloralin |
| Assembly | | |
| Inhibition of Microtubule | Dinitroanilines | Isopropalin |
| Assembly | | |
| Inhibition of Microtubule | Dinitroanilines | Nitralin |
| Assembly | | |
| Inhibition of Microtubule | Dinitroanilines | Prodiamine |
| Assembly | | |
| Inhibition of Microtubule | Dinitroanilines | Profluralin |
| Assembly | | |
| Inhibition of Microtubule | Dinitroanilines | Oryzalin |
| Assembly | | |
| Inhibition of Microtubule | Dinitroanilines | Pendimethalin |
| Assembly | | |
| Inhibition of Microtubule | Dinitroanilines | Trifluralin |
| Assembly | | |
| Inhibition of Microtubule | Pyridines | Dithiopyr |
| Assembly | | |
| Inhibition of Microtubule | Pyridines | Thiazopyr |
| Assembly | | |
| Inhibition of Microtubule | Phosphoroamidates | Butamifos |
| Assembly | | |
| Inhibition of Microtubule | Phosphoroamidates | DMPA |
| Assembly | | |
| Inhibition of Microtubule | Benzoic acid | Chlorthal-dimethyl═DCPA |
| Assembly | | |
| Inhibition of Microtubule | Benzamides | Propyzamide═pronamide |
| Assembly | | |
| Inhibition of Microtubule | Carbamates | Barban |
| Organization | | |
| Inhibition of Microtubule | Carbamates | Carbetamide |
| Organization | | |
| Inhibition of Microtubule | Carbamates | Chlorbufam |
| Organization | | |
| Inhibition of Microtubule | Carbamates | Chlorpropham |
| Organization | | |
| Inhibition of Microtubule | Carbamates | Propham |
| Organization | | |
| Inhibition of Microtubule | Carbamates | Swep |
| Organization | | |
| Inhibition of Cellulose | Triazolocarboxamide | Flupoxam |
| Synthesis | | |
| Inhibition of Cellulose | Benzamides | Isoxaben |
| Synthesis | | |
| Inhibition of Cellulose | Alkylazines | Triaziflam |
| Synthesis | | |
| Inhibition of Cellulose | Alkylazines | Indaziflam |
| Synthesis | | |
| Inhibition of Cellulose | Nitriles | Dichlobenil |
| Synthesis | | |
| Inhibition of Cellulose | Nitriles | Chlorthiamid |
| Synthesis | | |
| Uncouplers | Dinitrophenols | Dinosam |
| Uncouplers | Dinitrophenols | Dinoseb |
| Uncouplers | Dinitrophenols | DNOC |
| Uncouplers | Dinitrophenols | Dinoterb |
| Uncouplers | Dinitrophenols | Etinofen |
| Uncouplers | Dinitrophenols | Medinoterb |
| Inhibition of Very Long-Chain | Azolyl-carboxamides | Cafenstrole |
| Fatty Acid Synthesis | | |
| Inhibition of Very Long-Chain | Azolyl-carboxamides | Fentrazamide |
| Fatty Acid Synthesis | | |
| Inhibition of Very Long-Chain | Azolyl-carboxamides | Ipfencarbazone |
| Fatty Acid Synthesis | | |
| Inhibition of Very Long-Chain | α-Thioacetamides | Anilofos |
| Fatty Acid Synthesis | | |
| Inhibition of Very Long-Chain | α-Thioacetamides | Piperophos |
| Fatty Acid Synthesis | | |
| Inhibition of Very Long-Chain | Isoxazolines | Pyroxasulfone |
| Fatty Acid Synthesis | | |
| Inhibition of Very Long-Chain | Isoxazolines | Fenoxasulfone |
| Fatty Acid Synthesis | | |
| Inhibition of Very Long-Chain | Oxiranes | Indanofan |
| Fatty Acid Synthesis | | |
| Inhibition of Very Long-Chain | Oxiranes | Tridiphane |
| Fatty Acid Synthesis | | |
| Inhibition of Very Long-Chain | α-Chloroacetamides | Acetochlor |
| Fatty Acid Synthesis | | |
| Inhibition of Very Long-Chain | α-Chloroacetamides | Alachlor |
| Fatty Acid Synthesis | | |
| Inhibition of Very Long-Chain | α-Chloroacetamides | Allidochlor═CDAA |
| Fatty Acid Synthesis | | |
| Inhibition of Very Long-Chain | α-Chloroacetamides | Butachlor |
| Fatty Acid Synthesis | | |
| Inhibition of Very Long-Chain | α-Chloroacetamides | Butenachlor |
| Fatty Acid Synthesis | | |
| Inhibition of Very Long-Chain | α-Chloroacetamides | Delachlor |
| Fatty Acid Synthesis | | |
| Inhibition of Very Long-Chain | α-Chloroacetamides | Diethatyl-ethyl |
| Fatty Acid Synthesis | | |
| Inhibition of Very Long-Chain | α-Chloroacetamides | Dimethachlor |
| Fatty Acid Synthesis | | |
| Inhibition of Very Long-Chain | α-Chloroacetamides | Dimethenamid |
| Fatty Acid Synthesis | | |
| Inhibition of Very Long-Chain | α-Chloroacetamides | Metazachlor |
| Fatty Acid Synthesis | | |
| Inhibition of Very Long-Chain | α-Chloroacetamides | Metolachlor |
| Fatty Acid Synthesis | | |
| Inhibition of Very Long-Chain | α-Chloroacetamides | Pethoxamid |
| Fatty Acid Synthesis | | |
| Inhibition of Very Long-Chain | α-Chloroacetamides | Pretilachlor |
| Fatty Acid Synthesis | | |
| Inhibition of Very Long-Chain | α-Chloroacetamides | Propachlor |
| Fatty Acid Synthesis | | |
| Inhibition of Very Long-Chain | α-Chloroacetamides | Propisochlor |
| Fatty Acid Synthesis | | |
| Inhibition of Very Long-Chain | α-Chloroacetamides | Prynachlor |
| Fatty Acid Synthesis | | |
| Inhibition of Very Long-Chain | α-Chloroacetamides | Thenylchlor |
| Fatty Acid Synthesis | | |
| Inhibition of Very Long-Chain | α-Oxyacetamides | Mefenacet |
| Fatty Acid Synthesis | | |
| Inhibition of Very Long-Chain | α-Oxyacetamides | Flufenacet |
| Fatty Acid Synthesis | | |
| Inhibition of Very Long-Chain | Thiocarbamates | Butylate |
| Fatty Acid Synthesis | | |
| Inhibition of Very Long-Chain | Thiocarbamates | Cycloate |
| Fatty Acid Synthesis | | |
| Inhibition of Very Long-Chain | Thiocarbamates | Dimepiperate |
| Fatty Acid Synthesis | | |
| Inhibition of Very Long-Chain | Thiocarbamates | EPTC |
| Fatty Acid Synthesis | | |
| Inhibition of Very Long-Chain | Thiocarbamates | Esprocarb |
| Fatty Acid Synthesis | | |
| Inhibition of Very Long-Chain | Thiocarbamates | Molinate |
| Fatty Acid Synthesis | | |
| Inhibition of Very Long-Chain | Thiocarbamates | Orbencarb |
| Fatty Acid Synthesis | | |
| Inhibition of Very Long-Chain | Thiocarbamates | Pebulate |
| Fatty Acid Synthesis | | |
| Inhibition of Very Long-Chain | Thiocarbamates | Prosulfocarb |
| Fatty Acid Synthesis | | |
| Inhibition of Very Long-Chain | Thiocarbamates | Thiobencarb (═Benthiocarb) |
| Fatty Acid Synthesis | | |
| Inhibition of Very Long-Chain | Thiocarbamates | Tiocarbazil |
| Fatty Acid Synthesis | | |
| Inhibition of Very Long-Chain | Thiocarbamates | Tri-allate |
| Fatty Acid Synthesis | | |
| Inhibition of Very Long-Chain | Thiocarbamates | Vernolate |
| Fatty Acid Synthesis | | |
| Inhibition of Very Long-Chain | Benzofurans | Benfuresate |
| Fatty Acid Synthesis | | |
| Inhibition of Very Long-Chain | Benzofurans | Ethofumesate |
| Fatty Acid Synthesis | | |
| Auxin Mimics | Pyridine-carboxylates | Picloram |
| Auxin Mimics | Pyridine-carboxylates | Clopyralid |
| Auxin Mimics | Pyridine-carboxylates | Aminopyralid |
| Auxin Mimics | Pyridine-carboxylates | Halauxifen |
| Auxin Mimics | Pyridine-carboxylates | Florpyrauxifen |
| Auxin Mimics | Pyridyloxy-carboxylates | Triclopyr |
| Auxin Mimics | Pyridyloxy-carboxylates | Fluroxypyr |
| Auxin Mimics | Phenoxy-carboxylates | 2,4,5-T |
| Auxin Mimics | Phenoxy-carboxylates | 2,4-D |
| Auxin Mimics | Phenoxy-carboxylates | 2,4-DB |
| Auxin Mimics | Phenoxy-carboxylates | Clomeprop |
| Auxin Mimics | Phenoxy-carboxylates | Dichlorprop |
| Auxin Mimics | Phenoxy-carboxylates | Fenoprop |
| Auxin Mimics | Phenoxy-carboxylates | Mecoprop |
| Auxin Mimics | Phenoxy-carboxylates | MCPA |
| Auxin Mimics | Phenoxy-carboxylates | MCPB |
| Auxin Mimics | Benzoates | Dicamba |
| Auxin Mimics | Benzoates | Chloramben |
| Auxin Mimics | Benzoates | TBA |
| Auxin Mimics | Quinoline-carboxylates | Quinclorac |
| Auxin Mimics | Quinoline-carboxylates | Quinmerac |
| Auxin Mimics | Pyrimidine-carboxylates | Aminocyclopyrachlor |
| Auxin Mimics | Other | Benazolin-ethyl |
| Auxin Mimics | Phenyl carboxylates | Chlorfenac═fenac |
| Auxin Mimics | Phenyl carboxylates | Chlorfenprop |
| Auxin Transport Inhibitor | Aryl-carboxylates | Naptalam |
| Auxin Transport Inhibitor | Aryl-carboxylates | Diflufenzopyr-sodium |
| Inhibition of Fatty Acid | Benzyl ether | Cinmethylin |
| Thioesterase | | |
| Inhibition of Fatty Acid | Benzyl ether | Methiozolin |
| Thioesterase | | |
| Inhibition of Serine-Threonine | Other | Endothal |
| Protein Phosphatase | | |
| Inhibition of Solanesyl | Diphenyl ether | Aclonifen |
| Diphosphate Synthase | | |
| Inhibition of Lycopene | Triazole | Amitrole |
| Cyclase | | |
| Unknown | | Bromobutide |
| Unknown | | Cumyluron |
| Unknown | | Difenzoquat |
| Unknown | | DSMA |
| Unknown | | Dymron═Daimuron |
| Unknown | | Etobenzanid |
| Unknown | Arylaminopropionic acid | Flamprop-m |
| Unknown | | Fosamine |
| Unknown | | Methyldymron |
| Unknown | | Monalide |
| Unknown | | MSMA |
| Unknown | | Oleic acid |
| Unknown | | Oxaziclomefone |
| Unknown | | Pelargonic acid |
| Unknown | | Pyributicarb |
| Unknown | | Quinoclamine |
| Unknown | Acetamides | Diphenamid |
| Unknown | Acetamides | Naproanilide |
| Unknown | Acetamides | Napropamide |
| Unknown | Benzamide | Tebutam |
| Unknown | Phosphorodithioate | Bensulide |
| Unknown | Chlorocarbonic acids | Dalapon |
| Unknown | Chlorocarbonic acids | Flupropanate |
| Unknown | Chlorocarbonic acids | TCA |
| Unknown | Trifluoromethanesulfonanilides | Mefluidide |
| Unknown | Trifluoromethanesulfonanilides | Perfluidone |
| Unknown | | CAMA |
| Unknown | | Cacodylic acid |

APPENDIX 3

| Main Group and | Sub-group, class on | |
|---|---|---|
| Primary Site of | exemplifying Active | |
| Action | Ingredient | Active Ingredients |
| 1 | 1A | Alanycarb, Aldicarb, Bendiocarb, Benfuracarb, Butocarboxim, |
| Acetylcholinesterase (AChE) | Carbamates | Butoxycarboxim, Carbaryl, Carbofuran, Carbosulfan, |
| inhibitors | | Ethiofencarb, Fenobucarb, Formetanate, Furathiocarb, |
| Nerve action | | Isoprocarb, Methiocarb, Methomyl, Metolcarb, Oxamyl, |
| {Strong evidence that action at this | | Pirimicarb, Propoxur, Thiodicarb, Thiofanox, |
| protein is responsible for insecticidal | | Triazamate, Trimethacarb, XMC, Xylylcarb |
| effects} | 1B | Acephate, Azamethiphos, Azinphos-ethyl, Azinphos- |
| | Organophosphates | methyl, Cadusafos, Chlorethoxyfos, Chlorfenvinphos, |
| | | Chlormephos, Chlorpyrifos, Chlorpyrifos-methyl, |
| | | Coumaphos, Cyanophos, Demeton-S-methyl, Diazinon, |
| | | Dichlorvos/ DDVP, Dicrotophos, Dimethoate, |
| | | Dimethylvinphos, Disulfoton, EPN, Ethion, Ethoprophos, |
| | | Famphur, Fenamiphos, Fenitrothion, Fenthion, |
| | | Fosthiazate, Heptenophos, Imicyafos, Isofenphos, |
| | | Isopropyl O-(methoxyaminothio-phosphoryl) salicylate, |
| | | Isoxathion, Malathion, Mecarbam, Methamidophos, |
| | | Methidathion, Mevinphos, Monocrotophos, Naled, |
| | | Omethoate, Oxydemeton-methyl, Parathion, Parathion- |
| | | methyl, Phenthoate, Phorate, Phosalone, Phosmet, |
| | | Phosphamidon, Phoxim, Pirimiphos-methyl, Profenofos, |
| | | Propetamphos, Prothiofos, Pyraclofos, Pyridaphenthion, |
| | | Quinalphos, Sulfotep, Tebupirimfos, Temephos, Terbufos, |
| | | Tetrachlorvinphos, Thiometon, Triazophos, Trichlorfon, |
| | | Vamidothion |
| 2 | 2A | Chlordane, Endosulfan |
| GABA-gated chloride channel blockers | Cyclodiene | |
| Nerve action | Organochlorines | |
| {Strong evidence that action at this | 2B | Ethiprole, Fipronil |
| protein is responsible for insecticidal | Phenylpyrazoles (Fiproles) | |
| effects} | | |
| 3 | 3A | Acrinathrin, Allethrin, d-cis-trans Allethrin, d-trans Allethrin, |
| Sodium channel modulators | Pyrethroids Pyrethrins | Bifenthrin, Bioallethrin, Bioallethrin S-cyclopentenyl isomer, |
| Nerve action | | Bioresmethrin, Cycloprothrin, Cyfluthrin, beta-Cyfluthrin, |
| | | Cyhalothrin, lambda-Cyhalothrin, gamma-Cyhalothrin, |
| | | Cypermethrin, alpha-Cypermethrin, beta-Cypermethrin, |
| | | theta-cypermethrin, zeta-Cypermethrin, Cyphenothrin , |
| | | (1R)-trans-isomers], Deltamethrin, Empenthrin (EZ)-(1R)- |
| | | isomers], Esfenvalerate, Etofenprox, Fenpropathrin, |
| | | Fenvalerate, Flucythrinate, Flumethrin, tau-Fluvalinate, |
| | | Halfenprox, Imiprothrin, Kadethrin, Permethrin, Phenothrin |
| | | [(1R)-trans-isomer], Prallethrin, Pyrethrins (pyrethrum), |
| | | Resmethrin, Silafluofen, Tefluthrin, Tetramethrin, |
| | | Tetramethrin [(1R)-isomers], Tralomethrin, Transfluthrin, |
| {Strong evidence that action at this | 3B | DDT |
| protein is responsible for insecticidal | DDT | Methoxychlor |
| effects} | Methoxychlor | |
| 4 | 4A | Acetamiprid, Clothianidin, Dinotefuran, |
| Nicotinic acetylcholine receptor | Neonicotinoids | Imidacloprid, Nitenpyram, Thiacloprid, Thiamethoxam, |
| (nAChR) competitive modulators | 4B | Nicotine |
| Nerve action | Nicotine | |
| {Strong evidence that action at one or | 4C | Sulfoxaflor |
| more of this class of protein is | Sulfoximines | |
| responsible for insecticidal effects} | 4D | Flupyradifurone |
| | Butenolides | |
| | 4E | Triflumezopyrim |
| | Mesoionics | |
| | 4F | Flupyrimin |
| | Pyridylidenes | |
| 5 | Spinosyns | Spinetoram, Spinosad |
| Nicotinic acetylcholine receptor | | |
| (nAChR) allosteric modulators-Site | | |
| I | | |
| Nerve action | | |
| {Strong evidence that action at one or | | |
| more of this class of protein is | | |
| responsible for insecticidal effects} | | |
| 6 | Avermectins, | Abamectin, Emamectin benzoate, Lepimectin, Milbemectin |
| Glutamate-gated chloride | Milbemycins | |
| channel (GluCl) allosteric | | |
| modulators | | |
| Nerve and muscle action | | |
| {Strong evidence that action at one or | | |
| more of this class of protein is | | |
| responsible for insecticidal effects} | | |
| 7 | 7A | Hydroprene, Kinoprene, Methoprene |
| Juvenile hormone mimics | Juvenile hormone | |
| Growth regulation | analogues | |
| {Target protein responsible for biological | 7B | Fenoxycarb |
| activity is unknown, or uncharacterized} | Fenoxycarb | |
| | 7C | Pyriproxyfen |
| | Pyriproxyfen | |
| | 8A | Methyl bromide and other alkyl halides |
| Miscellaneous non-specific (multi- | Alkyl halides | |
| site) inhibitors | 8B | Chloropicrin |
| | Chloropicrin | |
| | 8C | Cryolite (Sodium aluminum fluoride), Sulfuryl fluoride |
| | Fluorides | |
| | 8D | Borax, Boric acid, Disodium octaborate, Sodium borate, |
| | Borates | Sodium metaborate |
| | 8E | Tartar emetic |
| | Tartar emetic | |
| | 8F | Dazomet, Metam |
| | Methyl isothiocyanate | |
| 8 * | generators | |
| 9 | 9B | Pymetrozine, Pyrifluquinazon |
| Chordotonal organ TRPV | Pyridine azomethine | |
| channel modulators Nerve action | derivatives | |
| {Strong evidence that action at one or | 9D | Afidopyropen |
| more of this class of proteins is | Pyropenes | |
| responsible for insecticidal effects} | | |
| 10 | 10A | Clofentezine, Diflovidazin, Hexythiazox |
| Mite growth inhibitors affecting | Clofentezine Diflovidazin | |
| CHS1 | Hexythiazox | |
| Growth regulation | | |
| {Strong evidence that action at one or | 10B | Etoxazole |
| more of this class of proteins is | Etoxazole | |
| responsible for insecticidal effects} | | |
| 11 | 11A | Bacillus thuringiensis subsp. israelensis Bacillus |
| Microbial disruptors of insect midgut | Bacillus thuringiensis and | thuringiensis subsp. aizawai Bacillus thuringiensis |
| membranes | the insecticidal proteins | subsp. kurstaki Bacillus thuringiensis subsp. |
| (Includes transgenic crops expressing | they produce | tenebrionis |
| Bacillus thuringiensis toxins, however | | B.t. crop proteins: (* Please see footnote) Cry1Ab, Cry1Ac, |
| specific guidance for resistance | | Cry1Fa, Cry1A.105, Cry2Ab, Vip3A, mCry3A, Cry3Ab, |
| management of transgenic crops is not | | Cry3Bb, Cry34Ab1/Cry35Ab1 |
| based on rotation of modes of action) | 11B | Bacillus sphaericus |
| | Bacillus sphaericus | |
| 12 | 12A | Diafenthiuron |
| Inhibitors of mitochondrial ATP | Diafenthiuron | |
| synthase | 12B | Azocyclotin, Cyhexatin, Fenbutatin oxide |
| Energy metabolism | Organotin miticides | |
| {Compounds affect the function of this | 12C | Propargite |
| protein, but it is not clear that this is what | Propargite | |
| leads to biological activity} | 12D | Tetradifon |
| | Tetradifon | |
| 13 * | Pyrroles Dinitrophenols | Chlorfenapyr DNOC |
| Uncouplers of oxidative | Sulfluramid | Sulfluramid |
| phosphorylation via disruption of | | |
| the proton gradient | | |
| Energy metabolism | | |
| 14 | Nereistoxin analogues | Bensultap, Cartap hydrochloride, Thiocyclam, |
| Nicotinic acetylcholine receptor | | Thiosultap-sodium |
| (nAChR) channel blockers | | |
| Nerve action | | |
| {Compounds affect the function of this | | |
| protein, but it is not clear that this is what | | |
| leads to biological activity} | | |
| 15 | Benzoylureas | Bistrifluron, Chlorfluazuron, Diflubenzuron, Flucycloxuron, |
| Inhibitors of chitin biosynthesis | | Flufenoxuron, Hexaflumuron, Lufenuron, Novaluron, |
| affecting CHS1 | | Noviflumuron, Teflubenzuron, Triflumuron |
| Growth regulation | | |
| {Strong evidence that action at one or | | |
| more of this class of proteins is | | |
| responsible for insecticidal effects} | | |
| 16 | Buprofezin | Buprofezin |
| Inhibitors of chitin biosynthesis, | | |
| type 1 | | |
| Growth regulation | | |
| {Target protein responsible for biological | | |
| activity is unknown, or uncharacterized} | | |
| 17 | Cyromazine | Cyromazine |
| Moulting disruptors, Dipteran | | |
| Growth regulation | | |
| {Target protein responsible for biological | | |
| activity is unknown, or uncharacterized} | | |
| 18 | Diacylhydrazines | Chromafenozide, Halofenozide, Methoxyfenozide, |
| Ecdysone receptor agonists | | Tebufenozide |
| Growth regulation | | |
| {Strong evidence that action at this | | |
| protein is responsible for insecticidal | | |
| effects} | | |
| 19 | Amitraz | Amitraz |
| Octopamine receptor agonists | | |
| Nerve action | | |
| {Good evidence that action at one or | | |
| more of this class of protein is | | |
| responsible for insecticidal effects} | | |
| 20 | 20A | Hydramethylnon |
| Mitochondrial complex III electron | Hydramethylnon | |
| transport inhibitors-Qo site | 20B | Acequinocyl |
| Energy metabolism | Acequinocyl | |
| {Good evidence that action at this | 20C | Fluacrypyrim |
| protein complex is responsible for | Fluacrypyrim | |
| insecticidal effects} | 20D | Bifenazate |
| | Bifenazate | |
| 21 | 21A | Fenazaquin, Fenpyroximate, Pyridaben, Pyrimidifen, |
| Mitochondrial complex I electron | METI acaricides and | Tebufenpyrad, Tolfenpyrad |
| transport inhibitors | insecticides | |
| Energy metabolism | 21B | Rotenone (Derris) |
| {Good evidence that action at this | Rotenone | |
| protein complex is responsible for | | |
| insecticidal effects} | | |
| 22 | 22A | Indoxacarb |
| Voltage-dependent sodium | Oxadiazines | |
| channel blockers | 22B | Metaflumizone |
| Nerve action | Semicarbazones | |
| {Good evidence that action at this | | |
| protein complex is responsible for | | |
| insecticidal effects} | | |
| 23 | Tetronic and Tetramic acid | Spirodiclofen, Spiromesifen, Spiropidion, Spirotetramat |
| Inhibitors of acetyl CoA carboxylase | derivatives | |
| Lipid synthesis, growth regulation | | |
| {Good evidence that action at this | | |
| protein is responsible for insecticidal | | |
| effects} | | |
| 24 | 24A | Aluminium phosphide, Calcium phosphide, Phosphine, Zinc |
| Mitochondrial complex IV electron | Phosphides | phosphide |
| transport inhibitors | | |
| Energy metabolism | | |
| {Good evidence that action at this | 24B | Calcium cyanide, Potassium cyanide, Sodium cyanide |
| protein complex is responsible for | Cyanides | |
| insecticidal effects} | | |
| 25 | 25A | Cyenopyrafen, Cyflumetofen |
| Mitochondrial complex Il electron | Beta-ketonitrile | |
| transport inhibitors | derivatives | |
| Energy metabolism | | |
| {Good evidence that action at this | 25B | Pyflubumide |
| protein | Carboxanilides | |
| complex is responsible for | | |
| insecticidal effects} | | |
| 28 | Diamides | Chlorantraniliprole, Cyantraniliprole, Cyclaniliprole |
| Ryanodine receptor | | Flubendiamide, Tetraniliprole |
| modulators | | |
| Nerve and muscle action | | |
| {Strong evidence that action at this | | |
| protein complex is responsible for | | |
| insecticidal effects} | | |
| 29 | Flonicamid | Flonicamid |
| Chordotonal organ modulators- | | |
| undefined target site | | |
| Nerve action | | |
| (Modulation of chordotonal organ | | |
| function has been clearly demonstrated, | | |
| but the specific target protein(s) | | |
| responsible for biological activity are | | |
| distinct from Group 9 and remain | | |
| undefined) | | |
| 30 | Meta-diamides Isoxazolines | Broflanilide |
| GABA-gated chloride channel allosteric | | Fluxametamide, Isocyloseram |
| modulators | | |
| Nerve action | | |
| {Strong evidence that action at this | | |
| protein complex is responsible for | | |
| insecticidal effects} | | |
| 31 | Granuloviruses (GVs) | Cydia pomonella GV |
| Baculoviruses | Nucleopolyhedroviruse s | Anticarsia gemmatalis MNPV |
| Host-specific occluded | (NPVs) | Helicoverpa armigera NPV |
| pathogenic viruses | | |
| (Midgut epithelial columnar cell | | |
| membrane target site-undefined) | | |
| 32 | GS-omega/kappa | GS-omega/kappa HXTX-Hv1a peptide |
| Nicotinic Acetylcholine Receptor | HXTX-Hv1a peptide | |
| (nAChR) Allosteric Modulators-Site II | | |
| Nerve action | | |
| {Strong evidence that action at one or | | |
| more of this class of protein is | | |
| responsible for insecticidal effects} | | |
| 33 | Acynonapyr | Acynonapyr |
| Calcium-activated potassium | | |
| channel (KCa2) modulators | | |
| Nerve action | | |
| {Strong evidence that action at this | | |
| protein is responsible for insecticidal | | |
| effects} | | |
| 34 | Flometoquin | Flometoquin |
| Mitochondrial complex III electron | | |
| transport inhibitors-Qi site | | |
| Energy metabolism | | |
| {Modulation of this protein complex has | | |
| been clearly demonstrated and the specific | | |
| target site responsible for biological activity | | |
| is distinct from Group 20} | | |
| UN* | Azadirachtin | Azadirachtin |
| Compounds of unknown or uncertain | Benzoximate | Benzoximate |
| MoA | Benzpyrimoxan | Benzpyrimoxan |
| {Target protein responsible for biological | Bromopropylate | Bromopropylate |
| activity is unknown, or uncharacterized} | Chinomethionat | Chinomethionat |
| | Dicofol | Dicofol |
| | Lime sulfur | Lime sulfur |
| | Mancozeb | Mancozeb |
| | Pyridalyl | Pyridalyl |
| | Sulfur | Sulfur |
| UNB* | | Burkholderia spp |
| Bacterial agents (non-Bt) of unknown or | | Wolbachia pipientis (Zap) |
| uncertain MoA | | |
| {Target protein responsible for biological | | |
| activity is unknown or uncharacterized} | | |
| UNE* | | Chenopodium ambrosioides near ambrosioides |
| Botanical essence including | | extract |
| synthetic, extracts and unrefined | | Fatty acid monoesters with glycerol or propanediol Neem oil |
| oils with unknown or uncertain MoA | | |
| {Target protein responsible for biological | | |
| activity is unknown, or uncharacterized} | | |
| UNF* | | Beauveria bassiana strains |
| Fungal agents of unknown or uncertain | | Metarhizium anisopliae strain F52 |
| MoA | | Paecilomyces fumosoroseus Apopka strain 97 |
| {Target protein responsible for biological | | |
| activity is unknown, or uncharacterized} | | |
| UNM* | | Diatomaceous earth |
| Non-specific mechanical and physical | | Mineral oil |
| disruptors | | |
| {Target protein responsible for biological | | |
| activity is unknown, or uncharacterized} | | |

We claim:

1. A composition, comprising:
a compound having a structure 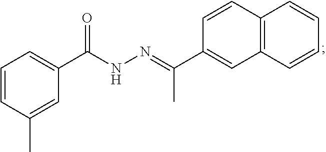 [SMILES: C/C(=N\NC(=O)c1cccc(C)c1)c1ccc2ccccc2c1]
a lipophilic solvent;
a first dispersant; and
a rheology modifier.

2. The composition of claim 1, wherein the compound is substantially insoluble in the lipophilic solvent.

3. The composition of claim 1, wherein the compound is present in the form of particles having a volume-weighted median particle size ranging from greater than 0.01 microns to 20 microns.

4. The composition of claim 3, wherein the volume-weighted median particle size is from 0.1 microns to 5 microns.

5. The composition of claim 1, wherein the volume-weighted median particle size of the compound, as measured by light scattering, is less than about 15 microns.

6. The formulation of claim 1, wherein the volume-weighted median particle size of the compound, as measured by light scattering, is less than about 7 microns.

7. The composition of claim 3, wherein the volume-weighted median particle size is from 0.5 microns to 2 microns.

8. The formulation of claim 1, wherein the volume-weighted median particle size of the compound, as measured by light scattering, is about 1 micron or less.

9. The composition claim 1, wherein the lipophilic solvent comprises mineral oil, a fatty acid, a vegetable or seed oil, a terpene, an aliphatic solvent, a cyclic hydrocarbon solvent, an aromatic solvent, or derivatives and/or combinations thereof.

10. The composition of claim 9, wherein the lipophilic solvent comprises a fatty acid derivative.

11. The composition of claim 10, wherein the fatty acid derivative is selected from fatty acid esters, fatty acid dialkyl amides and combinations thereof.

12. The composition of claim 10, wherein the fatty acid derivative comprises methyl oleate.

13. The composition of claim 9, wherein the lipophilic solvent comprises a paraffinic solvent.

14. The composition of claim 9, wherein the lipophilic solvent comprises an aromatic solvent.

15. The composition of claim 9, wherein the lipophilic solvent comprises tetrahydronaphthalene, alkylated naphthalenes, derivatives thereof, or combinations thereof.

16. The composition of claim 1, wherein the particles are present in an amount from 5 wt % to 90 wt %.

17. The composition of claim 1, wherein the rheology modifier comprises an organo-modified clay, a silica or hydrophobically-modified silica, an alumina, a polyurethane-based polymer, or a combination thereof, present in an amount of from 0.1 wt % to 15 wt %.

18. The composition of claim 1, wherein the first dispersant has a molecular weight of from 1,000 Daltons to 100,000 Daltons and is fully soluble in the lipophilic solvent; and
the first dispersant is an anionic dispersant, a cationic dispersant, a non-ionic dispersant, or a combination thereof.

19. The composition claim 18, wherein the first dispersant is present in an amount of from 0.1 wt % to 20 wt %.

20. The composition of claim 19, further comprising an emulsifier and a second dispersant.

21. The composition of claim 20, wherein the emulsifier has a molecular weight of from 150 Daltons to 1,200 Daltons.

22. The composition of claim 21, wherein the emulsifier is an anionic surfactant, a cationic surfactant, a nonionic surfactant, a quaternary ammonium surfactant, a zwitterionic surfactant, or a combination thereof.

23. The composition of claim 22, further comprising an agriculturally active compound A.

24. An agricultural composition, comprising water and/or a lipophilic solvent and the composition of claim 1.

25. The agricultural composition of claim 24, wherein the agricultural composition further comprises an agriculturally active compound B.

26. The composition of claim 22, wherein the composition or agricultural composition comprises at least one of agriculturally active compound A or agriculturally active compound B, and each of agriculturally active compound A and agriculturally active compound B independently is an acaricide, antimicrobial, fungicide, herbicide, insecticide, molluscicide, or nematocide, or a combination thereof.

27. The composition or agricultural composition of claim 26, wherein each of agriculturally active compound A and agriculturally active compound B independently is a fungicide.

28. The composition or agricultural composition of claim 27, wherein each of agriculturally active compound A and agriculturally active compound B independently is a fungicide selected from a benzimidazole fungicide, dicarboximide fungicide, phenylpyrrole fungicide, anilinopyrimidine fungicide, hydroxyanilide fungicide, carboxamide fungicide, phenylamide fungicide, phosphonate fungicide, cinnamic acid fungicide, OSBPI fungicide, triazole carboxamide fungicide, Group 27 fungicide, carbamate fungicide, benzamide fungicide, demethylation-inhibiting fungicide, piperazine fungicide, pyrimidine fungicide imidazole fungicide, triazole fungicide, morpholine fungicide, Group U6 fungicide, Group 50 fungicide, QoI strobilurin fungicide, quinoline fungicide, inorganic fungicide, copper fungicide, sulfur fungicide, lime sulfur fungicide, ethylenebisdithiocarbamate (EBDC) fungicide, EBDC-like fungicide, aromatic hydrocarbon fungicide, chloronitrile fungicide, phthalimide fungicide, guanidine fungicide, QiI fungicide, polyoxin fungicide, Group 29 fungicide, thiazolidine fungicide, or a combination thereof.

29. The composition or agricultural composition of claim 27, wherein each of agriculturally active compound A and agriculturally active compound B independently is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.

30. A method of using the agricultural composition of claim 24, applying the agricultural composition to a plant, a part of a plant, a seed, soil where a plant is or will be growing, or soil where a seed has been or will be sown.

31. A method for controlling or preventing fungal growth comprising:
diluting the composition of claim 1 with water and/or a lipophilic solvent to form a diluted mixture; and
applying the diluted mixture to a site that has a fungal growth or that is at risk of developing a fungal growth.

32. The method of claim 31, further comprising adding an agriculturally active compound.

33. The method of claim 32, wherein adding the agriculturally active compound comprises adding an amount of the agriculturally active compound that is less than an amount of the agriculturally active compound that is recommended for use in the absence of the composition of claim 1.

34. The method of claim 32, wherein the agriculturally active compound is a fungicide selected from a benzimidazole fungicide, dicarboximide fungicide, phenylpyrrole fungicide, anilinopyrimidine fungicide, hydroxyanilide fungicide, carboxamide fungicide, phenylamide fungicide, phosphonate fungicide, cinnamic acid fungicide, OSBPI fungicide, triazole carboxamide fungicide, Group 27 fungicide, carbamate fungicide, benzamide fungicide, demethylation-inhibiting fungicide, piperazine fungicide, pyrimidine fungicide imidazole fungicide, triazole fungicide, morpholine fungicide, Group U6 fungicide, Group 50 fungicide, QoI strobilurin fungicide, quinoline fungicide, inorganic fungicide, copper fungicide, sulfur fungicide, lime sulfur fungicide, ethylenebisdithiocarbamate (EBDC) fungicide, EBDC-like fungicide, aromatic hydrocarbon fungicide, chloronitrile fungicide, phthalimide fungicide, guanidine fungicide, QiI fungicide, polyoxin fungicide, Group 29 fungicide, thiazolidine fungicide, or a combination thereof.

35. The method of claim 32 wherein the agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.
